(19) United States
(12) Patent Application Publication
(10) Pub. No.: US 2006/0153283 A1
(43) Pub. Date: Jul. 13, 2006

(54) Interference cancellation in adjoint operators for communication receivers

(76) Inventors: Louis L. Scharf, Fort Collins, CO (US); Steve J. Shattil, Boulder, CO (US)

Correspondence Address: TENSORCOMM, INC., 1490 W. 121ST AVE., SUITE 105, WESTMINISTER, CO, 80234, US

(21) Appl. No.: 11/035,141

(22) Filed: Jan. 13, 2005

(51) Int. Cl. H04B 1/707; H04B 1/713

(52) U.S. Cl. 375/148; 375/136

(57) ABSTRACT

A receiver in a wireless communication system comprises a reverse transform configured to produce a vector of baseband signal values, and a projection canceller configured to project the vector of baseband signal values onto at least one subspace that is substantially orthogonal to an interference subspace. The reverse transform may be adjoint to a forward transform employed by at least one transmitter in the wireless communication system. The combination of interference cancellation with one or more receiver operations may be a substantially adjoint operation relative to one or more transmitter operators and channel-propagation effects. The reverse transform may include a Fourier transform, a wavelet transform, or any other well known invertible transforms. Reverse transforms may include spread-spectrum multiple-access coding and may be implemented in systems configured to perform single-input, multiple output or multiple-input, multiple-output operations. Interference components may be selected in a projection canceller relative to predetermined ratios of interference in the received signal.

### BACKGROUND

1. Field of the Invention

The invention generally relates to the field of signal processing. More specifically the invention is related to efficient mathematical projection of signals for the purpose of signal filtering in a reverse transform.

2. Discussion of the Related Art

Signal processing is the process of altering the characteristics of a signal in a desired way or deriving desired parameters from a signal. It is often used in the recovery of transmitted signals. While various forms of analog and digital signal processing exist, digital signal processing has become increasingly popular due to advances in digital processor technologies and the relative ease in operating with quantized representations of signals. Digital signal processing, in particular, provides a means to mitigate the effects of undesired signals (e.g., noise and/or interference) to more accurately recover a signal.

Digital signal filtering has long been used to separate desired components of a digital signal (i.e., symbols of interest) from undesired signal components. For example, a digital filter may be used to allow frequency components of a desired signal to pass while substantially blocking the frequency components of an undesired signal. In order to efficiently utilize time and frequency in a communication system, multiple-access schemes are used to specify how multiple users or multiple signals may share a common time and frequency allocation.

Spread-spectrum techniques may be used to allow multiple users and/or signals to share the same frequency band and time simultaneously. Code division multiple access (“CDMA”) is an example of spread spectrum that assigns a unique code to differentiate each signal and/or user. CDMA codes may be applied in the time domain (e.g., as direct-sequence coding), in the frequency domain, and/or across spatial subchannels. The codes are typically designed to have minimal cross-correlation to mitigate interference. However, even with a small cross-correlation between codes, CDMA is an interference-limited system. Digital filters that only pass or block selected frequency bands of a signal to filter out unwanted frequency bands are not applicable because CDMA signals share the same frequency band.

Examples of CDMA communication systems include global positioning systems (“GPS”) and CDMA wireless telephony. The multiple access coding schemes specified by standards thereby provide “channelization,” or channel separability, for the system. In a typical CDMA wireless telephony system, a transmitter may transmit a plurality of signals in the same frequency band by using a combination of spreading codes and/or covering codes. For example, each transmitter may be identified by a unique spreading code or spreading-code offset. Moreover, a single transmitter may transmit a plurality of signals sharing the same spreading code, but may distinguish between signals with a unique covering code. Covering codes further encode the signal and provide channelization of the signal. Spreading codes and covering codes are known to those skilled in the art.

While certain signaling implementations, such as the coding schemes of CDMA, have been useful in efficiently utilizing a given frequency band, these coded signals may still interfere with one another. For example, coded signals may interfere due to similarities in codes and associated signal energy. Lack of orthogonality between these signals results in “leakage” from one signal into another. Examples of this leakage include “co-channel” and “cross-channel” interference. Co-channel interference may include multipath interference from the same transmitter, wherein a transmitted signal takes unique paths that causes one path (e.g., an interfering signal path) and another path (e.g., a selected signal path) to differentially arrive at a receiver, thereby hindering reception of the selected signal path. Cross-channel interference may include interference caused by signal paths of other transmitters hindering the reception of the selected signal path.

Interference can degrade communications by causing a receiver to incorrectly recover transmitted data. Interference may also have other deleterious effects on communications. For example, interference may diminish the capacity of a communication system, decrease the region of coverage, and/or decrease maximum data rates. For these reasons, a reduction in interference may improve signal processing of selected signals while addressing the aforementioned limitations due to interference.

Certain types of projection techniques have been developed which project a received signal onto a subspace that is orthogonal to interfering signals. Thus, a signal of interest may be decomposed into a component that lies in a subspace that is orthogonal to a subspace containing the interference and a component that is co-linear with the interference subspace.

### SUMMARY

A receiver embodiment of the invention comprises a reverse transform and a projection canceller. The reverse transform may operate on a received signal in one or more signal spaces to produce a vector of baseband signal values. Each baseband signal value may correspond to a subspace having a linear combination of transmitted data symbols. The projection canceller is typically used to cancel one or more interfering signals from at least one signal of interest. For example, the projection canceller may project the vector of baseband signal values onto a signal space (e.g., a signal subspace) that is substantially orthogonal to an interference signal space.

The combination of the reverse transform and the projection canceller may comprise a receiver operator that is substantially adjoint to at least one transmitter operator comprising at least one forward transform and, optionally, channel distortions. Receiver operators and transmitter operators may include orthogonal or biorthogonal operators. A reverse transform may include an equalizer and/or a matched filter, and a forward transform may include a precoder.

A forward transform may also be referred to as a synthesis stage or a generalized transmitter. A reverse transform may include an analysis stage or a generalized receiver. Forward and reverse transforms may employ invertible N-point transforms, such as a discrete Fourier transform (DFT), in combination with at least one spreading code. In some embodiments of the invention, one or more communication links may be implemented by transmitting signals over the same subset of frequency channels via linearly independent (orthogonal or non-orthogonal) sets of spreading codes. A receiver may perform a reverse transform that includes despreading, followed by interference cancellation, to separate the signals. Spreading codes can include direct-sequence codes (i.e., time-domain spread-spectrum codes and/or CDMA codes), frequency-domain codes (e.g., multi-carrier CDMA, spread-OFDM, etc.), and spreading codes that exploit spatial sub-channels. Other types of spreading codes and combinations thereof may be employed to distribute one or more data symbols over a plurality of signal subspaces. The use of orthogonal-projection techniques and/or oblique-projection techniques for interference cancellation, in combination with invertible transforms, allows some embodiments of the invention to advantageously combine equalization and interference mitigation.

In one embodiment of the invention, transmitted data symbols are mapped using a forward transform prior to transmission. A receiver according to this embodiment employs a corresponding reverse transform (which is adjoint to the forward transform) to recover data symbol estimates. These estimates may comprise estimates of decoded data symbols and/or estimates of code chips of coded data symbols. However, channel distortions affecting the transmitted data symbols can cause inter-symbol interference (ISI) and/or multiple-access interference (MAI) in the data symbol estimates. Similarly, transmitter and/or receiver imperfections resulting in frequency offsets and phase jitter can cause ISI and MAI. Other types of distortion and imperfections can also lead to ISI and MAI. Therefore, receiver embodiments may include a projection operator adapted to project the data symbol estimates onto a subspace that is substantially orthogonal to an interference subspace spanned by selected interfering signals.

Some channel distortions can cause interference in invertible transforms. For example, frequency offsets, such as resulting from Doppler shifts or receiver/transmitter synchronization mismatch, can cause interference (i.e., overlap between frequency bins) in a DFT. Thus, in one aspect of the previously mentioned receiver embodiment, the projection operator may be adapted to cancel transform leakage (e.g., subchannel) interference.

In combined transforms, such as Fourier transforms that also employ spreading, it is common for channel distortions to cause interference. For example, in spread-OFDM, data symbols are modulated onto orthogonal spreading codes, and then different modulated code chips are applied to different frequency bins of an inverse DFT (IDFT). A multipath-fading environment that distorts the transmitted spreading codes impedes the orthogonality of the codes. Thus, in another aspect of the previously mentioned receiver embodiment, the projection operator is adapted to cancel ISI and/or MAI resulting from non-orthogonal spreading codes, whether caused by the transmitter or the channel. In a related embodiment of the invention, non-orthogonal spreading codes may be employed at the transmitter. A projection operator at a receiver then effectively orthogonalizes the received spreading codes.

System embodiments of the invention may employ forward and/or reverse transforms configured to generate subcarrier values characterized by linear combinations of transmitted data symbols. Such embodiments may advantageously produce subcarrier values that are linearly independent combinations of at least one signal of interest and at least one interfering signal. This allows a cancellation operator to separate the at least one signal of interest from the interference. Transforms adapted to produce linearly independent combinations of data symbols may include orthogonal or non-orthogonal transforms.

An alternative receiver embodiment of the invention may include providing for equalization after applying a reverse transform to a received signal. Often, equalization does not completely mitigate ISI and MAI. Also, other types of interference may be present in the received signal. Therefore, a receiver according to this alternative embodiment may employ a projection operator after an equalizer to cancel residual interference in the equalized signal.

Another exemplary receiver embodiment is configured to apply an equalized transform to a received signal followed by interference cancellation for recovering estimates of the transmitted data symbols. The equalized transform includes a reverse version of a forward invertible transform used to map data symbols in a transmission process. However, the reverse transform may be adapted to compensate for one or more channel distortions in the received signal. The receiver according to this embodiment may use a projection operator to cancel interference in the data symbol estimates.

Yet another exemplary receiver embodiment is configured to apply a forward invertible transform to a received signal, followed by equalization, and then followed by a reverse transform corresponding to the forward invertible transform. Interference cancellation may be performed before and/or after the reverse transform.

Particular embodiments of the invention provide for frequency-domain analysis and/or synthesis for time-domain single-carrier signals, including (but not limited to) direct-sequence CDMA signals. Such embodiments may provide system-integration advantages, such as compatibility with discrete multi-tone and OFDM frequency channelization techniques. Such embodiments allow stationary and linear channel distortions to be modeled as a multiplicative effect on spectral components of the spreading code. Thus, in some embodiments of the invention, equalization may reduce to complex multiplications that are automatically subsumed into the cancellation operation.

These and other embodiments of the invention are described with respect to the figures and in the following description of the preferred embodiments.

### BRIEF DESCRIPTION OF THE DRAWINGS

FIG. 1A illustrates a functional embodiment of the invention for conveying data through a communication channel.

FIG. 1B shows a portion of a system embodiment of the invention in which data is operated on via a forward transform, transmitted through a communication channel, and then processed via a reverse transform.

FIG. 1C illustrates how a reverse transform maps data values of a received signal onto a first subspace.

FIG. 1D illustrates how a reverse transform maps data values of a received signal onto an M^{th} subspace.

FIG. 1E is a graphical illustration representing interference cancellation via an orthogonal projection.

FIG. 1F shows a receiver embodiment of the present invention.

FIG. 1G shows a transmitter embodiment and a receiver embodiment of the invention.

FIG. 1H illustrates source-code segments of a receiver software program residing on a computer-readable memory.

FIG. 2A illustrates a functional embodiment of the invention, wherein a forward-transform operator is expressed by a spreading or precoding operation and an invertible transform. In this case, a reverse-transform operator is expressed by an invertible transform operation and an optional matched filter or equalizer.

FIG. 2B represents transmitter and receiver embodiments of the invention in which one or more transmitters may be configured to encode a plurality of transmission signals with linearly independent spreading gains.

FIG. 2C conveys method and apparatus embodiments of the invention in which a plurality of spectrally similar transmissions are provided with channel distortions to produce a plurality of linearly independent spectral components at a receiver.

FIG. 2D is a block diagram that illustrates receiver apparatus and method embodiments of the invention.

FIG. 2E shows an embodiment of an interference canceller, including an interference projector, an interference selector, an optional combiner, and a demodulator/decision module.

FIG. 2F illustrates a transmitter embodiment of the invention configured to achieve an advantageous balance between peak-to-average power of a transmitted signal and bandwidth efficiency.

FIG. 2G shows a receiver embodiment of the invention that includes characterizing MAI and/or ISI in a received baseband signal, followed by interference selection and interference cancellation.

FIG. 3A shows an exemplary system embodiment of the invention in which forward and reverse transforms include N-point invertible transforms.

FIG. 3B illustrates an exemplary application of a sliding transform embodiment of the invention. A sliding transform may be employed by either a forward transform or a reverse transform.

FIG. 3C illustrates a receiver embodiment of the invention in which spectral components produced by a sliding transform may be combined with respect to each of a plurality of time-shifted block transforms.

FIG. 4A illustrates a set of receiver embodiments of the invention in which interference cancellation may be performed at any of four points in the receiver.

FIG. 4B illustrates a communication system in which a forward transform and a reverse transform comprise a multiple-input/multiple-output operation.

FIG. 5A illustrates an exemplary receiver embodiment wherein a reverse transform may comprise receiving transmitted signals with an M-element array and separating the received signals into spectral components by a plurality of FFTs FIG. 5B shows a receiver embodiment in which an interference canceller includes an interference-canceller network. Embodiments of the invention may employ parallel and/or serial interference cancellers.

FIG. 6 illustrates an exemplary receiver embodiment including a reverse transform implemented with an M-element array and a plurality of Rake receivers.

FIG. 7 illustrates a receiver embodiment of the invention configured to provide a reverse transform via a plurality M of polarized receivers.

FIG. 8A shows a block diagram of an exemplary OFDM communication system that may be configured to transmit and receive frequency-hopped signals. The exemplary OFDM communication system includes a receiver comprising an interference selector and an interference canceller that may be employed for canceling one or more interfering signals.

FIG. 8B shows an FFT block that may be used to process a plurality of time-offset and/or frequency-offset signals.

FIG. 9A illustrates a receiver embodiment of the invention.

FIG. 9B illustrates an alternative receiver embodiment.

FIG. 10A illustrates a reception-method embodiment of the invention.

FIG. 10B illustrates an iterative method for updating at least one signal-of-interest estimate.

FIG. 11A illustrates a CDMA receiver embodiment of the invention that is configured to perform frequency-domain interference cancellation.

FIG. 11B illustrates an exemplary embodiment of a frequency-domain interference-cancellation system.

FIG. 11C shows an alternative embodiment of an interference-cancellation system.

FIG. 11D shows an exemplary embodiment of an interference-cancellation system configured to perform frequency-domain interference cancellation.

FIG. 11E illustrates an interference-cancellation receiver embodiment wherein interference cancellation is performed following a descrambler.

FIG. 12A is a block diagram of an apparatus and method embodiment of the invention configured for performing iterative feedback interference cancellation.

FIG. 12B is a flow chart representing an iterative feedback interference cancellation embodiment of the invention.

### DESCRIPTION OF THE PREFERRED EMBODIMENTS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the spirit and scope of the invention as defined by the claims.

In one embodiment of the invention, interference cancellation is implemented via a projection operator having the following form:
P_{S}^{⊥}=I−S(S^{H}S)⁻¹S^{H},
where P_{S}^{⊥} is the projection operator, I is an identity matrix, S is an interference matrix, and S^{H} is a conjugate transpose (i.e. Hermitian transpose) of the interference matrix S. In many cases, various signal properties, such as correlation properties between the columns of S, can be used to simplify the expression of the projection operator P_{S}^{⊥} without sacrificing a significant amount of performance. For example, some signal spaces allow for an accurate approximation for P_{S}^{⊥} expressed by:
P_{S}^{⊥}=I−S(S^{T}S)⁻¹S^{T},
where S^{T} is a transpose of the interference matrix. Alternative approximations may be provided for the projection operator P_{S}^{⊥} and/or one or more of its components, such as is well known in the art. In a linear-processing embodiment of the invention, a projection operator having the following form may be employed:
P_{S}^{⊥}=1−S(S^{T}S)⁻¹S^{T},

In one receiver embodiment, one or more interfering signals may be selected or resolved from a received digital signal y and used to construct the interference matrix S. Various interference selection and projection techniques are described in U.S. patent application Ser. No. 10/294,834, filed Nov. 15, 2003, which is incorporated by reference in its entirety. Each column vector of the interference matrix S may represent one or more interfering signals.

An application of the projection operator P_{S}^{⊥} to the input signal y projects the input signal y onto a signal space that is substantially orthogonal to a signal space comprising one or more interfering signals:
P_{S}^{⊥}y=(I−P_{S})y=y−S(S^{H}S)⁻¹S^{H}y
This projection can substantially remove the effects of the interfering signal(s) upon a desired signal (i.e., a signal of interest) because the energy of the interfering signal(s) is substantially reduced in relation to the energy of the signals not selected for cancellation. In some embodiments of the invention, an orthogonal projection P_{S}^{⊥} of signal y may be performed after separating both S and y into their respective in-phase (I) and quadrature-phase (Q) components. Thus, the projection P_{S}^{⊥} may be simplified if certain simplifying assumptions are made with respect to correlations (for example) between the various I and Q components.

Alternative projection operators may be provided. For example, a projection operator may include regularisation parameters in the variance matrix (S^{H}S)⁻¹ or (S^{T}S)⁻¹. Some embodiments of the invention may employ estimation techniques to enhance or simplify the projection operator. Enhancements may include removing an interference noise floor to obtain more accurate estimates of interference vectors in matrix S. Similarly, iterative and/or feedback techniques may be employed to optimize the S matrix. In some cases, one or more matrices in the projection operator may be approximated by diagonal or almost-diagonal matrices.

In the case where S is a matrix, a set of column vectors s₀, . . . , s_{N-1} in S may be orthogonalized in order to simplify calculations of the (S^{T}S)⁻¹ term. This may be done by employing the Gram-Schmidt algorithm, or a modified Gram-Schmidt algorithm, such as described in U.S. patent application Ser. No. 10/294,834, filed Nov. 15, 2003, which is hereby incorporated by reference. The unitary basis vectors of S are given by [Uₙ₋₁,uₙ] with:
uₙ=P_{U}_{_{n−1}}^{⊥}sₙ; where u₀=s₀ and Uₙ₋₁=[u₀, u₁, . . . , uₙ₋₁]
The term P_{U}_{_{n−1}}^{⊥} represents the orthogonal projection of sₙ onto the space spanned by Uₙ₋₁=[u₀, u₁, . . . , uₙ₋₁]. The unitary vectors uₙ are columns of a unitary matrix U and the projection operator P_{U}^{⊥} is expressed by:
P_{U}^{⊥}=I−U(U^{H}U)⁻¹U^{H}=P_{S}^{⊥}
Since unitary vectors have zero cross-correlation, the matrix term U^{H}U is diagonal, which makes its inverse simpler to calculate than performing a full matrix inverse. Similarly, if the projection operator P_{U}^{⊥} is expressed in terms of transpose operations instead of Hermitian operations, one can derive the orthogonal basis vectors of S.

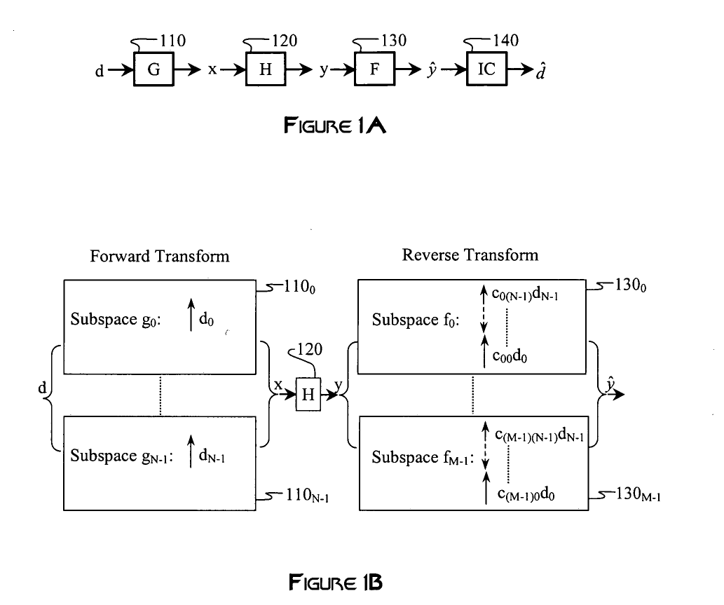

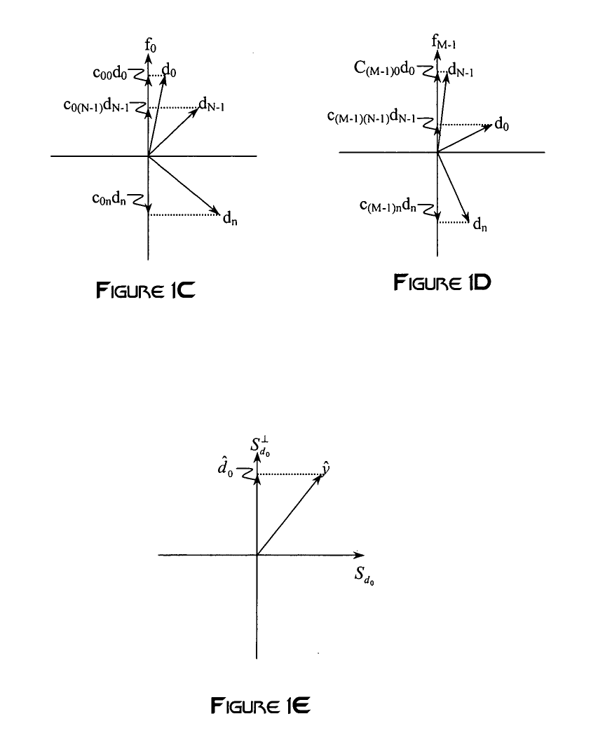

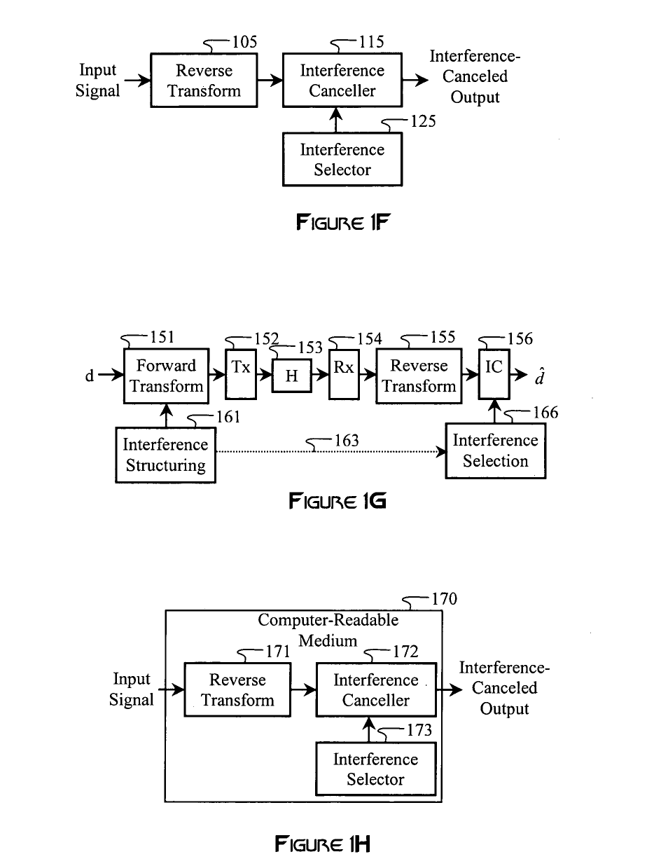

FIG. 1A illustrates a functional embodiment of the invention for conveying data through a communication channel 120. A plurality N of data symbols d={d₀, . . . , d_{N-1}} is mapped 110 onto at least one signal subspace (e.g., a code subspace, a frequency subspace, a path-diversity subspace, a wavelet subspace, a polarization subspace, etc.) by at least one forward-transform operator G. At least one transmitted subspace signal x propagates through the channel 120 and is operated on by a channel matrix H. Received transmissions are converted to received baseband signals y prior to being reverse-transformed 130 by a reverse-transform operator F, which is adjoint to the forward-transform operator G (i.e., FG=I).

In one embodiment of the invention, the forward-transform operator G is a synthesis operator that may be represented by a polyphase matrix G(z). Similarly, the reverse-transform operator F is an analysis operator that may be represented by a polyphase matrix F(z) that is the adjoint of matrix G(z). In general, the reverse transform F provides the necessary condition to reconstruct data symbols operated on by the forward transform G, making a filter bank FG a perfect reconstruction filter.

The reverse transform F is operable to decompose received signals y into a form represented by a predetermined set of basis functions. The reverse transform F of a signal y produces at least one vector of complex values ŷ₀ representing a linear combination of the basis functions. The vector (i.e., the linear combination of basis functions) represents the algebraic structure of the set of signals.

In some embodiments of the invention, the forward-transform operator G and the reverse-transform operator F comprise orthogonal operators, or basis functions. In particular, normalized orthogonal (orthonormal) vectors are defined by the following inner-product relationship: [symbol]
vₘ,vₙ [symbol] =δₘₙ
Similarly, orthonormal functions are defined by:

$${\int }_{2}^{b} {ϕ}_{m} ( t ) {ϕ}_{n} ( t ) ⅆ t = {δ}_{mn}$$

In such embodiments, the adjoint of the forward-transform operator G may be itself.

The Fourier transform decomposes time-domain samples of a received signal into orthogonal frequency components expressed by a vector of complex values. These complex values represent frequency-component weights that could be used to substantially synthesize the received time-domain signal. Similarly, other reverse transforms may be used to decompose a received signal into components corresponding to orthogonal basis functions. For example, an orthogonal wavelet transform may express a signal with respect to a set of orthogonal wavelet basis functions. A Walsh transform could be used to express a digital sequence as a linear combination of Walsh codes. Other types of transforms, such as Hankel transforms, may be employed.

Some embodiments of the invention may employ biorthogonal bases. In such embodiments, the transform operators G and F (e.g., the adjoint of G) employ different bases that are orthogonal to each other, but do not form an orthogonal set themselves. A biorthogonal (i.e., bi-orthonormal) set of bases ψ and φ can be expressed by: [symbol]
φₘ,ψₙ [symbol] =δₘₙ
where ψₙ≠φₙ.

In some embodiments of the invention, the reverse transform 130 may employ a reverse-transform operator F that does not operate in the same signal space as the basis functions employed by the forward-transform operator G. In one exemplary embodiment of the invention, the operator G employs orthogonal direct-sequence codes having predetermined spectral profiles. The operator F may process received baseband signals in the frequency domain by first separating the received signals into discrete spectral components and then applying orthogonal frequency-domain despreading codes to decode the transmitted data symbols. In this exemplary embodiment, the operator G employs orthogonal time-domain basis functions, whereas operator F employs orthogonal frequency-domain basis functions. However, operator F can still be the adjoint of operator G. Thus, embodiments of the invention may provide for substantially adjoint operations G and F wherein G and F operate in different signal spaces.

The received baseband signal y can be expressed as:
y=Hx=HGd,
which is operated upon by the reverse-transform operator F to produce a reverse-transform signal ŷ:
ŷ=Fy=FHGd
However, the channel operator H often prevents the operator HG from being adjoint to F. Thus, an equalization operator E may be applied to the received baseband signal y to compensate for at least some of the channel distortions. In one exemplary embodiment, an equalized reverse-transform signal ŷ may be expressed by:
ŷ=FEy=FEHGd
Channel equalization is never perfect (i.e., E≠H⁻¹), thus any problems associated with HG not being adjoint to F are usually not completely ameliorated by the equalization operator E. In fact, it is common for equalization to increase the noise floor.

Therefore, exemplary embodiments of the invention provide for an interference canceller 140 (e.g., a projection canceller) that includes at least one projection operator P_{S}^{⊥}. Projection operators, such as the projection operator P_{S}^{⊥}, may be applied to ŷ to produce an interference-cancelled reverse-transform vector ŷ_{ic}:
ŷ_{ic}=P_{S}^{⊥}ŷ=P_{S}^{⊥}FHGd,
or ŷ_{ic}=P_{S}^{⊥}ŷ=P_{S}^{⊥}FEHGd
where the projection operator P_{S}^{⊥} is configured to project ŷ onto a subspace that is substantially orthogonal to an interference subspace defined by one or more selected interference components of FHGd or FEHGd.

In other embodiments of the invention, projection operators P_{S}^{⊥} may be applied to the received baseband signal y as follows:
\hat{d}=F(H^{T}P_{S}^{⊥}H)⁻¹H^{T}P_{S}^{⊥}y=F(H^{T}P_{S}^{⊥}H)⁻¹H^{T}P_{S}^{⊥}HGd,
or \hat{d}=F(\overline{H}^{T}P_{S}^{⊥}\overline{H})⁻¹\overline{H}^{T}P_{S}^{⊥}y=F(\overline{H}^{T}P_{S}^{⊥}\overline{H})⁻¹\overline{H}^{T}P_{S}^{⊥}\overline{H}Gd
where \overline{H}=EH. In these embodiments, an enhanced reverse-transform operator F(H^{T}P_{S}^{⊥}H)⁻¹H^{T}P_{S}^{⊥} is substantially adjoint to an effective forward-transform operator HG, and an enhanced reverse-transform operator F(\overline{H}^{T}P_{S}^{⊥}\overline{H})⁻¹\overline{H}^{T}P_{S}^{⊥} is substantially adjoint to an effective forward-transform operator EHG. Thus, some receiver embodiments of the invention may employ one or more projection operators P_{S}^{⊥} in combination with at least one reverse-transform operator F to produce an enhanced reverse-transform operator that is substantially adjoint to the combined channel matrix/forward-transform operator HG (or EHG). In some applications, the projection operators P_{S}^{⊥} may be adaptable to compensate for changing channel conditions.

Since the enhanced reverse-transform operators F(H^{T}P_{S}^{⊥}H)⁻¹H^{T}P_{S}^{⊥} and F(\overline{H}^{T}P_{S}^{⊥}\overline{H})⁻¹\overline{H}^{T}P_{S}^{⊥} are provided to be substantially adjoint to effective forward-transform operators HG and EHG, respectively, the transform operators G and F may employ non-orthogonal basis functions. Furthermore, the operators G and F may be responsive to changing channel conditions. In some embodiments, G (and optionally, F) may be selected to structure the interference in the received signals, such as to limit or reduce the number of required interference components in matrix S.

In another embodiment of the invention, a projection operator P_{S}^{⊥} may be applied to a received baseband signal y=HGd to produce an estimated data vector \hat{d}:
\hat{d}=(\overline{H}^{T}P_{S}^{⊥}\overline{H})⁻¹\overline{H}^{T}P_{S}^{⊥}y=(\overline{H}^{T}P_{S}^{⊥}\overline{H})⁻¹\overline{H}^{T}P_{S}^{⊥}HGd
where \overline{H}=HG. In this case, enhanced forward-transform operator (\overline{H}^{T}P_{S}^{⊥}\overline{H})⁻¹\overline{H}^{T}P_{S}^{⊥} is preferably substantially adjoint to HG. Thus, the forward-transform operator G may not be constrained by any orthogonality requirements.

In another embodiment, the forward-transform operator G may take the form G=BA wherein A is a spreading matrix and B is a transform operator with an associated adjoint operator \tilde{B}. If B is an orthogonal N×N matrix, then \tilde{B}=B and B^{T}B=I. The reverse-transform operator F may take the form F=B^{T}. A projection operator P_{S}^{⊥} can be applied to an invertible-transformed (B^{T}) received signal yᵢ=B^{T}y=B^{T}HBAd to produce an estimated data vector \hat{d}:
\hat{d}=(\overline{H}^{T}P_{S}^{⊥}\overline{H})⁻¹\overline{H}^{T}P_{S}^{⊥}yᵢ=(\overline{H}^{T}P_{S}^{⊥}\overline{H})⁻¹\overline{H}^{T}P_{S}^{⊥}B^{T}HBAd
wherein \overline{H}≈B^{T}HBA, and the projection operator P_{S}^{⊥} is configured to project the received signal yᵢ onto a subspace that is orthogonal to at least one interference subspace resulting from the spreading matrix A and the channel distortions H. In this case, an enhanced reverse-transform operator (\overline{H}^{T}P_{S}^{⊥}\overline{H})⁻¹\overline{H}^{T}P_{S}^{⊥} is substantially adjoint to an effective forward-transform operator B^{T}HBA. Similarly, an enhanced reverse-transform operator (\overline{H}^{T}P_{S}^{⊥}\overline{H})⁻¹\overline{H}^{T}P_{S}^{⊥}B^{T} can be regarded as substantially adjoint to an effective forward-transform operator HBA. Thus, in some embodiments of the invention, the spreading matrix A may employ non-orthogonal basis functions. Similarly, the transform operator B may be non-orthogonal.

In FIG. 1B, a forward transform is configured to process an input data sequence d{d₀, . . . , d_{N-1}} to produce a baseband transmission signal, or composite signal, x={x₀, . . . , x_{N-1}} expressed by x=G·d. In this exemplary embodiment, each data symbol dₙ is mapped onto a plurality of forward-transform subspaces 110₀-110_{N-1}, which may also be denoted as g₀ to g_{N-1}. In other embodiments, the baseband transmission vector x may be larger or smaller than the data vector d. A baseband transmission vector x may be written with respect to a particular desired data symbol (i.e., a symbol of interest) d₀ as:

$$x = {g}_{0} {d}_{0} + {\sum }_{n = 1}^{N - 1} {g}_{n} {d}_{n}$$

where the terms g₀ to g_{N-1} represent transform vectors or waveforms of G, and the data symbols d₀ to d_{N-1} are scalar quantities. The baseband transmission vector x is typically conditioned for communication through a predetermined communication channel 120 (e.g., D/A converted, filtered, frequency up-converted, and amplified) and a transmit signal derived therefrom is coupled into the communication channel 120.

As the transmitted signal propagates through the channel 120, channel distortions (such as multipath, Doppler, etc.) can alter the data mapping. In various types of signaling systems, channel distortions cause loss of orthogonality between data symbols that were mapped onto orthogonal signal subspaces, resulting in inter-symbol interference (ISI) and/or multiple-access interference (MAI).

The distorted transmission signal is coupled out of the channel 120 by a receiver and converted to a baseband format to produce a received signal vector y, which is also a composite signal comprising a linear combination of the mapped data symbols. However, various distortions, including channel effects, may prevent the reverse-transform operator F from completely separating the transmitted data d. The received vector y can be expressed by a channel-distorted version of the transmission signal vector x:

$$y = {α}_{0} {g}_{0} {d}_{0} + {\sum }_{n = 1}^{N - 1} {α}_{n} {g}_{n} {d}_{n} + {β}_{0} {g}_{0}^{′} {d}_{0} + {\sum }_{n = 1}^{N - 1} {β}_{n} {g}_{n}^{′} {d}_{n} + η$$

where the first term representing y is the symbol of interest d₀ mapped by vector g₀ and scaled by a complex-valued channel-response term α₀. The second term represents undistorted portions of the mapped (gₙ) symbols dₙ scaled by channel-response terms αₙ. The third term provides for any self-interference, which is scaled by term β₀ and includes an effective (e.g., a distorted) transform vector g₀′ that is not orthogonal to the adjoint of g₀. In some cases, the self-interference term can be incorporated into the channel-response term α₀, or vice versa. The fourth term indicates interference with the other mapped symbols dₙ scaled by βₙ and mapped onto effective transform vectors gₙ′ that are not adjoint or orthogonal to gₙ. In some embodiments of the invention, the fourth term may represent interference from previously transmitted symbols that are sufficiently delayed by the channel to interfere with the current measurement of y. The fifth term η represents additive noise to the measurement of y.

The received composite signal y is operated on by at least one substantially reverse transform F to separate it into a plurality of baseband signal portions ŷₘ, m={0, . . . , M−1}, with respect to reverse-transform subspaces f₀ to f_{M-1} (130₀-130_{M-1}). For example, a decode transform vector f₀, where (fₘgₙ=δₘₙ), may be a vector component of a matrix F and wherein g₀ is a corresponding vector component of a matrix G. If an orthogonal transform square matrix G is used, then:
F=G⁻¹=G^{T}
The expression for a baseband signal portion ŷ₀ is expressed by:
ŷ₀=f₀y
where f₀g₀=1, f₀g_{n≠0}=0, f₀g₀′=c₀₀, and f₀g_{n≠0}′=c₀ₙ. Thus, ŷ₀ is given by:

$${\hat{y}}_{0} = {α}_{0} {d}_{0} + {c}_{00} {d}_{0} + {\sum }_{k = 1}^{N - 1} {c}_{0 k} {d}_{k}$$

where cₙₙ {n=0} represents self-interference and c_{n,k≠n} represents cross-correlation interference terms. A phasor representation of interfering data values dₙ in the baseband signal portion ŷ₀ is illustrated with respect to the reverse-transform subspace f₀ (130₀).

FIG. 1C illustrates how the data values dₙ are mapped onto subspace f₀ to produce the phasor representation shown with respect to subspace 130₀. For simplicity, the term α₀ may be incorporated into c₀₀. The contribution of noise, although not shown explicitly, is manifested as uncertainty in the estimate of ŷ₀. Similarly, the expression for a baseband signal portion ŷ_{M-1} is:

$${\hat{y}}_{M - 1} = {f}_{M - 1} y = {c}_{( M - 1 ) 0} {d}_{0} + {\sum }_{k = 1}^{N - 1} {c}_{( M - 1 ) k} {d}_{k} ,$$

which is illustrated by a phasor representation 130_{M-1} of interfering data values dₙ with respect to a reverse-transform subspace f_{M-1}. FIG. 1D illustrates how the data values dₙ are mapped onto subspace f_{M-1}.

If M=N, the expression for the baseband signal components ŷ={ŷ₀, . . . , ŷ_{N-1} } with respect to the symbol of interest d₀ can be expressed as:

$$\vert \begin{matrix}{\hat{y}}_{0} \\ ⋮ \\ {\hat{y}}_{N - 1}\end{matrix} \vert = \vert \begin{matrix}{c}_{00} & {c}_{01} ⋯ {c}_{0 ( N - 1 )} \\ ⋮ & ⋮ \\ {c}_{( N - 1 ) 0} & {c}_{( N - 1 ) 1} ⋯ {c}_{( N - 1 ) ( N - 1 )}\end{matrix} \vert \vert \begin{matrix}{d}_{0} \\ {d}_{1} \\ ⋮ \\ {d}_{N - 1}\end{matrix} \vert$$

where the terms in the first matrix column are scalar values and the terms in the second matrix column are intended to convey vectors if N>2. Similarly, d₀ represents a symbol of interest in data vector d, and terms d_{1, . . . ,N-1} represent the other potentially interfering values. The expression for vector ŷ can also be written with respect to a vector subspace h corresponding to the data symbol of interest d₀ and an interference subspace S:

$$\hat{y} = \vert h S \vert \qquad \vert \begin{matrix}{d}_{0} \\ {d}_{1} \\ ⋮ \\ {d}_{N - 1}\end{matrix} \vert where h = \vert \begin{matrix}{c}_{00} \\ {c}_{10} \\ ⋮ \\ {c}_{( N - 1 ) 0}\end{matrix} \vert , and \\ S = \vert \begin{matrix}{c}_{01} & ⋯ & {c}_{0 ( N - 1 )} \\ ⋮ & & ⋮ \\ {c}_{( N - 1 ) 1} & ⋯ & {c}_{( N - 1 ) ( N - 1 )}\end{matrix} \vert$$

Although the interference subspace S is shown as a matrix, it may be implemented as a vector using techniques that are well known in the art. For example, the interference subspace S may include a linear combination of interference-vector subspaces.

FIG. 1E is a graphical illustration representing interference cancellation via orthogonal projection. An estimated value \hat{d}₀ for data symbol d₀ is generated by projecting the vector ŷ onto a subspace S^{⊥} that is substantially orthogonal to the interference subspace S:
\hat{d}₀=(h^{T}P_{S}^{⊥}h)⁻¹h^{T}P_{S}^{⊥}ŷ
The term P_{S}^{⊥} is a projection operator that projects a predetermined input onto the subspace S^{⊥}.

Interference cancellation includes selecting one or more interference components to include in the interference subspace S. A correlation of the orthogonally projected vector ŷ with a reference vector in the direction of the signal of interest d₀ thereby substantially eliminates the contribution of the interference S to the signal of interest d₀. The projection, in this embodiment, results in recovering a substantial portion of the signal of interest d₀ without the interference S.

FIG. 1F shows a receiver embodiment of the present invention. An interference canceller 115 coupled to an interference selector 125 follows a reverse transform 105. The reverse transform 105 may be adapted to provide any combination of reverse-transform operations relative to one or more forward transforms (not shown) provided to data symbols by a transmitter (not shown). Alternatively, the reverse transform 105 may operate on a received signal regardless of how the transmitted signal is generated. The reverse transform 105 may optionally include an equalizer or a matched filter. The reverse transform 105 generates a plurality of baseband symbols, which is used as an input signal to the cancellation operator 115. The interference canceller 115 includes a projection operator adapted to project the input signal onto a subspace that is substantially orthogonal to an interference subspace spanned by at least one selected interfering signals. The interference selector 125 is adapted to select one or more interference components to include in the interference subspace.

In one set of embodiments, the forward-transform operator G can be expressed by a matrix comprising transform vectors gₙ that map each data symbol dₙ onto an associated signal subspace. For example, an invertible orthogonal transform, such as a DFT, maps each data symbol to an orthogonal frequency bin (i.e., a frequency subspace). Similarly, a Walsh transform maps each data symbol to an orthogonal code subspace. Furthermore, a Wavelet transform maps each data symbol onto a subspace defined by a family of wavelets. Embodiments of the invention may employ alternative transforms to map data symbols to signal subspaces that may or may not be orthogonal to each other.

Some embodiments of the invention provide for advantageously selecting which interference vectors to include in S for constructing the projection operator P_{S}^{⊥}. For example, such selections may be made to optimize at least one predetermined performance metric, such as signal-to-noise ratio (SNR), bit-error rate (BER), packet-error rate (PER), frame-error rate (FER), mean-squared error (MSE), or the like. In one aspect of the invention, the interference may be characterized with respect to the signal of interest such that determinations may be made as to if and/or how to cancel particular interference components. For example, a decision may be made not to cancel interference that occupies a signal subspace that is substantially similar to the signal of interest. Thus, a receiver embodiment of the invention may include an interference selector coupled to a projection canceller configured to select interfering signals for cancellation based on their correlation with at least one signal of interest. Such selections may also be made to control or limit receiver processing complexity. In some cases, predetermined interference thresholds may be employed, such as to provide for optimizing a performance/processing complexity trade-off.

Some embodiments of the invention may provide for structuring, or distributing, the interference across one or more signal subspaces in a predetermined manner. In FIG. 1G, a forward transform 151 is provided with interference structuring 161 to process data prior to transmission 152 into a communication channel 163. The forward-transform module 151 may include an interference-structuring module 161, which may select or shape the forward transform operation applied to transmission data. Such embodiments may be directed to reducing ISI and/or MAI, limiting the impact of each interfering signal to a small number of symbols and/or multiple-access channels, and/or providing for predictable interference distributions. Known interference distributions can be used to simplify selection of interference components (e.g., interference vectors) 166 that are included in the interference subspace S. Those skilled in the art will recognize additional and alternative advantages to providing for structuring interference in transmitted and/or received signals.

Transmissions are received 154 from the channel 153 and processed in a reverse transform 155 to produce a plurality of baseband signals. The structure (i.e., the distribution) of the interference may be measured or predetermined analytically by a receiver as part of a decision process that includes selecting interference components 166 to include in the interference subspace S. Accordingly, an optional communicative coupling 163 between interference structuring 161 and interference selection 166 may provide the receiver with information about the signal structure of a transmission. This information, in combination with measured or statistically assumed channel conditions, can provide an estimated interference structure at the receiver that can be used to select interference components. The receiver may infer the interference structure from known spreading codes or other transmission characteristics. Similarly, channel estimation or received-signal measurements can be used to characterize the interference structure, and thus facilitate interference selection 166. Interference cancellation 156 constructs the projection operator P_{S}^{⊥} from the selected interference components

A transmitter may employ a variety of signal processing techniques to structure interference in a received transmission. For example, a transmitter may employ one or more data-spreading codes designed to substantially constrain interference (e.g., symbol leakage) to one or more adjacent symbols or codes. Similarly, the transmitter may employ preceding in order to compensate for at least some of the channel distortion in the propagation environment. Transmitter coding may include adaptive and/or retro-directive coding.

The transmitter may be configured to decouple a plurality of transmitted data symbols, data streams, and/or multiple-access channels received at a receiver. For example, in a flat fading channel, a plurality of subcarriers separated by less than the coherence bandwidth of the channel may be lost due to a deep fade. If orthogonal spreading codes are employed, the loss of many subcarriers typically results in loss of orthogonality. Thus, a multicarrier transmission may be provided with a subcarrier spacing that meets or exceeds the coherence bandwidth of the channel to reduce the effects of multipath interference. The invention may employ frequency interleaving, which is well known in the art. Similarly, array spacing, beam forming, and antenna polarization diversity may be employed to help decouple the effects of channel dispersion and interference. Furthermore, multi-element processing (e.g., antenna-array processing) may be performed at a receiver in order to achieve any of a variety of signal-processing benefits, including reducing interference.

Some embodiments of the invention may be directed toward providing interference cancellation in a frequency-domain receiver for direct-sequence CDMA systems, such as (but not limited to) cdmaOne, cdma2000, 1xRTT, cdma 1xEV-DO, cdma 1xEV-DV and cdma2000 3x), WCDMA, Broadband CDMA, Universal Mobile Telephone System (“UMTS”), HSDPA, and GPS. For example, a received CDMA signal can be decomposed into a plurality of spectral components wherein each spectral component represents a linear combination of desired and interfering signals. One embodiment of the invention provides for projecting the spectral components of the received CDMA signal onto a subspace that is substantially orthogonal to an interference subspace defined by spectral components of at least one interfering signal. Another embodiment provides for optionally equalizing one or more of the subspace components, followed by despreading to produce multiple algebraically unique linear combinations of interfering signals. Sets of de-spread signals are then projected onto a subspace that is substantially orthogonal to one or more interfering signals. Alternatively, an oblique projection operator may be applied to the despread signals.

The invention is not intended to be limited to the preferred embodiments. Furthermore, those skilled in the art should recognize that the method and apparatus embodiments described herein may be implemented in a variety of ways, including implementations in hardware, software, firmware, or various combinations thereof. Examples of such hardware may include Application Specific Integrated Circuits (ASICs), Field Programmable Gate Arrays (FPGAs), general-purpose processors, Digital Signal Processors (DSPs), and/or other circuitry. Software and/or firmware implementations of the invention may be implemented via any combination of programming languages, including Java, C, C++, Matlab, Verilog, VHDL, and/or processor specific machine and assembly languages.

Computer programs (i.e., software and/or firmware) implementing the method of this invention may be distributed to users on a distribution medium such as a SIM card, a USB memory interface, or other computer-readable memory adapted for interfacing with a consumer wireless terminal. Similarly, computer programs may be distributed to users via wired or wireless network interfaces. From there, they will often be copied to a hard disk or a similar intermediate storage medium. When the programs are to be run, they may be loaded either from their distribution medium or their intermediate storage medium into the execution memory of a wireless terminal, configuring an onboard digital computer system (e.g. a microprocessor) to act in accordance with the method of this invention. All these operations are well known to those skilled in the art of computer systems.

FIG. 1H illustrates a reverse transform source code segment 171, an interference canceller source code segment 172, and an interference selector source code segment 173 residing on a computer readable medium 170. The term “computer-readable medium” encompasses distribution media, intermediate storage media, execution memory of a computer (or other digital processing system), and any other medium or device capable of storing for later reading by a digital computer system a computer program implementing the method of this invention.

Various digital computer system configurations can be employed to perform the method embodiments of this invention, and to the extent that a particular system configuration is capable of performing the method embodiments of this invention, it is equivalent to the representative system embodiments of the invention disclosed herein, and within the scope and spirit of this invention.

Once digital computer systems are programmed to perform particular functions pursuant to instructions from program software that implements the method embodiments of this invention, such digital computer systems in effect become special-purpose computers particular to the method embodiments of this invention. The techniques necessary for this programming are well known to those skilled in the art of computer systems.

I. Interference Cancellation for Multicarrier Spreading

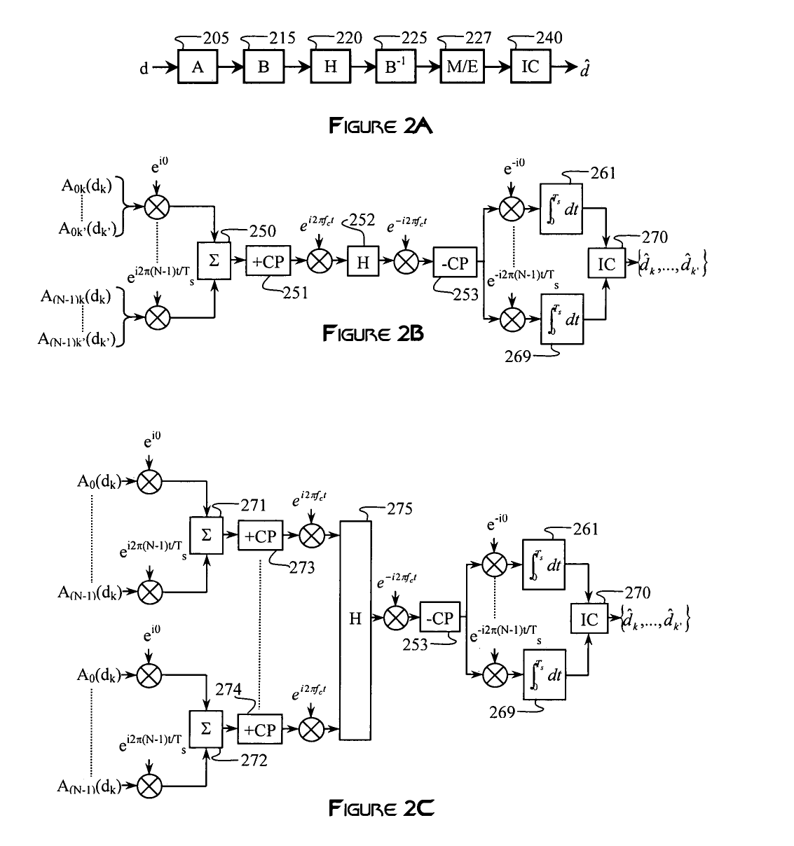

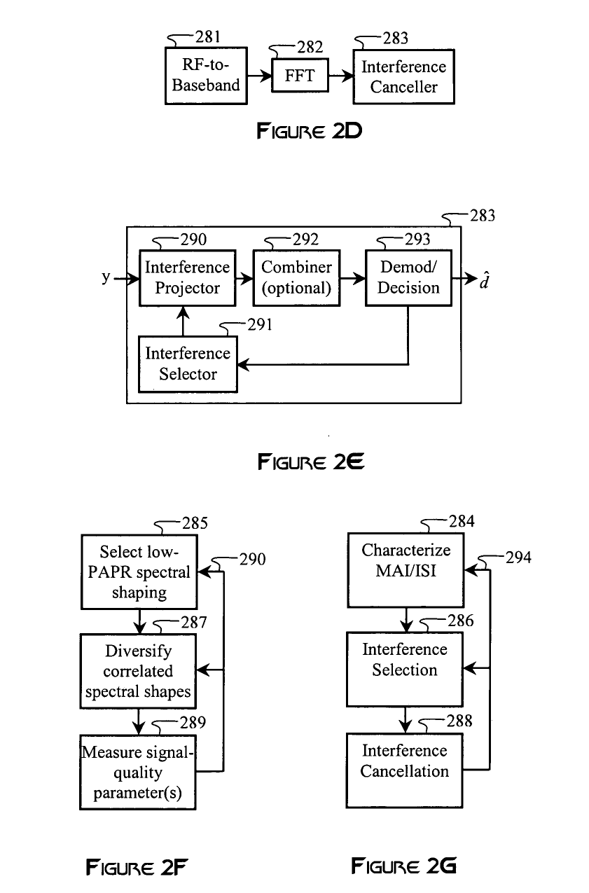

FIG. 2A illustrates a functional embodiment of the invention, wherein a forward-transform operator G is expressed by a spreading or precoding operation 205 (e.g., a matrix A) and an invertible transform operation 215 (represented by matrix B). A reverse-transform operator F is expressed by an invertible transform operation 225 (represented by matrix B⁻¹) and an optional matched filter or equalizer 227 (which is labeled “M/E”).

If matrix A is orthogonal, it has rows and/or columns representative of orthogonal basis vectors, or codes. Accordingly, embodiments of the invention may employ well-known orthogonal transforms, such as Walsh, Fourier, and Wavelet transforms. In one embodiment of the invention, the spreading and/or precoding operation 227 precedes the invertible transform operation 225. Thus, the matrix G may be expressed as: G=BA.

A reverse-transform matrix F can be expressed as FG=I. If A and B are N×N square matrices, one embodiment of the invention may specify that
F=G⁻¹=(BA)⁻¹=A⁻¹B⁻¹.
The M/E module 227 may be adapted to substantially reverse the operation performed by the spreading/precoding operation 205 and/or channel distortions 220 (represented by matrix H). Matched filtering may include applying an inverse operator A⁻¹ prior to interference cancellation (IC) 240.

In an exemplary signal-processing method pertaining to a multicarrier transceiver embodiment of the invention, a forward-transform operator G comprising an N×N spreading matrix A maps each data symbol dₖ in a data vector d=[d₀, . . . , d_{N-1}]^{T} into a transmit vector x=[x₀, . . . , x_{N-1}]^{T}, where x=Gd. Alternatively, a non-square (e.g., N×M, where M≠N) matrix G may be employed. The operator G also includes providing the vector x to input bins of an N-point forward transform, such as an IFFT.

A diagonal channel matrix H characterizes fading (e.g., flat fading) on each transform sub-channel (i.e., subcarrier frequency). A signal received from the channel is processed by an N-point reverse transform that is the adjoint of the N-point forward transform (such as an FFT) to produce a vector of received frequency-bin values y. The vector y is a composite signal consisting of linear combinations of the data vector d values. The received composite signal y=[y₀, . . . , y_{N-1}]^{T} can be expressed by:
y=Hx+η=HGd+η
where η=[η₀, . . . , η_{N-1}]^{T} is a vector containing the corresponding noise terms with ηₙ representing the noise term at the n^{th} subchannel.

In a multicarrier receiver, the received composite signal y(t) produced after the invertible transform B⁻¹ is expressed by:

$$y ( t ) = {\sum }_{n = 0}^{N - 1} [ {\sum }_{k = 0}^{K - 1} {A}_{nk} {d}_{k} ] {H}_{n} {ⅇ}^{ⅈ2π n t / {T}_{s}} + η ( t )$$

where N is the number of orthogonal subcarriers, K is the number of transmitted symbols dₖ in a symbol period Tₛ, Hₙ is a complex-valued flat-fading coefficient corresponding to an n^{th} subcarrier, and Aₙₖ represents spreading terms in the spreading or preceding matrix A, which maps each data symbol dₖ onto one or more subcarriers. K≦N is selected for orthogonal mappings, and K>N is typically (but not necessarily always) selected for pseudo-orthogonal mappings.

In the case where K=N and the received composite signal y(t) is mapped onto orthogonal basis subcarriers, the vector of subcarrier symbol values y is:

$$\vert \begin{matrix}y ( 0 ) \\ ⋮ \\ y ( N - 1 )\end{matrix} \vert = \vert h S \vert \vert \begin{matrix}{d}_{0} \\ {d}_{1} \\ ⋮ \\ {d}_{N - 1}\end{matrix} \vert$$

$$where$$

$$h = \vert \begin{matrix}{H}_{0} {A}_{00} \\ ⋮ \\ {H}_{N - 1} {A}_{( N - 1 ) 0}\end{matrix} \vert , and S = \vert \begin{matrix}{H}_{0} {A}_{01} & ⋯ & {H}_{0} {A}_{0 ( N - 1 )} \\ ⋮ & & ⋮ \\ {H}_{N - 1} {A}_{( N - 1 ) 1} & ⋯ & {H}_{N - 1} {A}_{( N - 1 ) ( N - 1 )}\end{matrix} \vert$$

The term h represents a vector subspace corresponding to a desired data symbol (i.e., a symbol of interest) d₀, and S represents an interfering signal subspace including non-orthogonal mappings of the data symbols d₁ . . . d_{N-1}.

An estimated value \hat{d}₀ for data symbol d₀ can be generated by projecting the symbol values of y onto a subspace that is substantially orthogonal to the interference subspace S:
\hat{d}₀=(h^{T}P_{S}^{⊥}h)⁻¹h^{T}P_{S}^{⊥}y
The term P_{S}^{⊥} is a projection operator for a subspace that is substantially orthogonal to S. Matrix S comprises one or more vectors and is typically generated via measurements of interfering signals when known training signals are transmitted. However, other methods may be employed for determining vector components in S.

In one embodiment of the invention, each of a plurality of potentially interfering signals (e.g., interference code spaces) may be correlated with a received signal to produce a correlation signal that indicates a relative degree of interference. When the correlation signal exceeds a predetermined signal-power threshold, the corresponding interference code space is included as a vector component in S. In some cases, code spaces corresponding to signals that are known to be present (e.g., common channels, active traffic channels, etc.) may be included in S. Similarly, code spaces corresponding to signals that are likely to be present may be included in S.

In some embodiments of the invention, it may be desirable to avoid projecting a received signal onto a subspace that is substantially orthogonal to a code space of a signal of interest in order to avoid attenuating the signal of interest. Thus, a process for determining vector components in S may employ some code-space discrimination means configured to discard interference code spaces that are highly correlated with at least one signal of interest. In one embodiment, the correlation between a signal-of-interest code space and at least one interference code-space may be calculated. In another embodiment, versions of a received signal before and after a projection may be compared, then the signal with the highest SNR retained.

In one embodiment of the invention, measured sub-carrier coefficients Hₙ and knowledge about matrix A (and/or G) may be used to determine the strongest interference sources, which then are used to derive the S vectors. Alternatively, adaptive techniques may be used to find values of S that optimize some predetermined signal-quality parameter, such as SNR, BER, PER, FER, etc. Some embodiments may provide for iteratively selecting columns and/or rows of S until some predetermined performance threshold is met.

Multicarrier spreading matrices are well known in the art and may include various types of well-known codes, such as Hadamard-Walsh codes, complex codes derived from DFT coefficients, Frank-Zadoff codes, and Chu sequences. Other spreading codes may also be employed. When multicarrier spreading is provided, subcarrier frequencies may be selected to optimize frequency-diversity benefits. For example, frequency-domain interleaving is a well-known technique used to reduce coherence between individual subcarriers.

Alternative embodiments of the invention may employ pseudo-random or other non-orthogonal coding. In these cases, the objective is to spread data symbols in a way that ensures that received symbols are provided with algebraically unique (i.e., linearly independent) spectral distributions, or spectral gain profiles. The application of projection operators to such received frequency-domain signals y facilitates separation of interfering data symbols dₙ.

In one embodiment of the invention, one or more transmitters may be configured to encode a plurality of transmission signals with linearly independent spreading gains. For example, in FIG. 2B, multiple data symbols dₖ to d_{k′} are provided with spreading codes (A₀ₖ to A_{(N-1)k} and A_{0k′} to A_{(N-1)k′}, respectively) having linearly independent spreading gains prior to being impressed onto carriers eⁱ⁰ to e^{i2π(N-1)t/T}^{ₛ}. The process of modulating coded data symbols onto the carriers and summing 250 the carriers to produce a time-domain signal output x(t) typically involves an invertible transform, such as an IFFT. A cyclic prefix (or some other type of guard interval) may optionally be added 251 to the signal x(t) prior to frequency up-conversion to a carrier frequency f_{c}.

A received signal, which may be distorted by the propagation channel 252, is down converted and the cyclic prefix is removed 253. An invertible transform, such as an FFT, produces sub-carrier symbols from sub-carrier frequency bins integrated 261-269 over at least one symbol period Tₛ. An interference canceller 270 generates estimated data symbols \hat{d}ₖ to \hat{d}_{k′} by projecting the sub-carrier symbols onto a subspace that is substantially orthogonal to an interference subspace.

In this exemplary embodiment, the receiver does not employ a despreading operator that is adjoint to the spreading operator A. Rather, the interference canceller 270 may function as a substantially adjoint operator relative to the combined effects of the spreading operator A and the channel 252. Such exemplary receiver embodiments may be employed in multicarrier spread-spectrum as a means for reducing despreading complexity and/or mitigating interference.

A person of ordinary skill in the art should appreciate that the receiver embodiment shown in FIG. 2B may be configured to separate any type of signal into spectral components. Thus, receiver embodiments of the invention may process single carrier and/or multicarrier signals as if they are multicarrier signals employing linearly independent spectral (i.e., frequency-domain) spreading codes. In some embodiments of the invention, the received signal may be configured to include signals that can be expressed by linearly independent spectral components.

II. Spatial Demultiplexing for Spectrally Unique Received Signals

In another embodiment of the invention, the communication channel is deliberately used to impart linearly independent spreading gains to the transmissions. In one exemplary embodiment, transmissions having the same spectral profile may be transmitted from spatially separated transmitters or otherwise provided with unique propagation characteristics. This enables one possible receiver embodiment of the invention to cancel interfering signals transmitted with the same signal (e.g., code) structure as the signal of interest.

FIG. 2C conveys method and apparatus embodiments of the invention in which a plurality of spectrally similar transmissions are provided with channel distortions to produce a plurality of linearly independent spectral components at a receiver. Multiple data symbols dₖ to d_{k′} are provided with the same spreading code (A₀ₖ to A_{(N-1)k}) prior to being impressed onto carriers eⁱ⁰ to e^{i2π(N-1)i/T}^{ₛ} and summed 271-272. Alternatively, the data symbols dₖ to d_{k′} may be similarly spread in the time domain (e.g., via direct-sequence coding). A cyclic prefix is optionally added 273-274 to the signal prior to frequency up-conversion to a carrier frequency f_{c}.

A communication channel 275 may be adapted to operate on the transmissions to produce a plurality of received signals characterized by linearly independent spreading gains (i.e., spectral components). For example, the communication channel 275 may be conditioned to impart linearly independent channel distortions Hₙₖ to similarly coded transmissions. Channel conditioning may include providing for spatial (i.e., path) diversity in which similarly spread Aₙ signals are transmitted from different antennas or transmitted with different beam patterns such that they experience substantially different propagation conditions. A receiver embodiment of the invention may be adapted to receive transmitted signals residing on a plurality of non-orthogonally polarized carriers, interfering signals having different delay profiles, and/or interfering signals having different spectral profiles.

An expression for the received signal y is:

$$\vert \begin{matrix}{y}_{0} \\ ⋮ \\ {y}_{N - 1}\end{matrix} \vert = \vert \begin{matrix}{H}_{00} {A}_{0} & ⋯ & {H}_{0 ( N - 1 )} {A}_{0} \\ ⋮ & & ⋮ \\ {H}_{( N - 1 ) 0} {A}_{( N - 1 )} & ⋯ & {H}_{( N - 1 ) ( N - 1 )} {A}_{( N - 1 )}\end{matrix} \vert \vert \begin{matrix}{d}_{0} \\ ⋮ \\ {d}_{N - 1}\end{matrix} \vert$$

where the channel terms Hₙₖ provide for linearly independent spreading. The vector of subcarrier symbol values y can also be expressed by:

$$\vert \begin{matrix}y ( 0 ) \\ ⋮ \\ y ( N - 1 )\end{matrix} \vert = \vert h S \vert \vert \begin{matrix}{d}_{0} \\ {d}_{1} \\ ⋮ \\ {d}_{N - 1}\end{matrix} \vert where h = \vert \begin{matrix} {H}_{ 00} {A}_{0} \\ ⋮ \\ {H}_{( N - 1 ) 0} {A}_{( N - 1 )}\end{matrix} \vert , and$$

$$S = \vert \begin{matrix}{H}_{01} {A}_{0} & ⋯ & {H}_{0 ( N - 1 )} {A}_{0} \\ ⋮ & & ⋮ \\ {H}_{( N - 1 ) 1} {A}_{( N - 1 )} & ⋯ & {H}_{( N - 1 ) ( N - 1 )} {A}_{( N - 1 )}\end{matrix} \vert$$

An estimated value \hat{d}₀ for data symbol d₀ can be generated by projecting the symbol values of y onto a subspace that is substantially orthogonal to the interference subspace S:
\hat{d}₀=(h^{T}P_{S}^{⊥}h)⁻¹h^{T}P_{S}^{⊥}y
where the term P_{S}^{⊥} is a projection operator for a subspace that is substantially orthogonal to S. A receiver method and apparatus identical to that shown in FIG. 2B processes the received signals to generate estimated data symbols \hat{d}ₖ to \hat{d}_{k′}.

In one embodiment of the invention, spreading codes (such as the spreading codes Aₙₖ and Aₙ described with respect to FIGS. 2B and 2C) provide for frequency interleaving or otherwise spread data over widely separated frequency bands for spectral diversity. In some embodiments of the invention, the spreading codes may provide for frequency-domain pulse shaping. In particular, spreading codes may include frequency-domain window coefficients that are appropriate for predetermined spectral shaping and/or time-domain pulse shaping. Thus, the spreading codes may employ well-known pulse-shaping coefficients, including (but not limited to) raised cosine, Kaiser-Bessel, Hamming, Hanning, and Gaussian coefficients. Alternative pulse shaping may be provided to the digital transmission signal following summing 250, 271, and/or 272. For example, digital pulse-shaping filters (not shown) may be employed. Similarly, spectral-smoothing functions are typically included in the cyclic prefix or guard interval.

FIG. 2D is a block diagram that illustrates a receiver embodiment of the invention. An RF-to-baseband converter 281 is coupled to an invertible transform (such as an FFT 282), which is coupled to an interference canceller 283. The RF-to-baseband converter 281 is configured to convert signals received from a communication channel into digital baseband signals. Thus, the RF-to-baseband converter 281 may include well-known RF front-end elements, such as an amplifier, a passband filter, a frequency down-converter, an ADC, a pulse-shaping filter, and a cyclic-prefix remover. Alternative configurations of the RF-to-baseband converter 281 may be employed without departing from the scope of the invention.

The FFT 282 is configured to separate the digital baseband signals into a plurality of subchannel (e.g., subcarrier) components. Similarly, the invention may employ any other invertible transform that is capable of providing a plurality of signal outputs comprising linear combinations of transmitted data symbols. Alternative invertible transforms include (but are not limited to) passband filter banks and quadrature-mirror filter banks. The interference canceller 283 is adapted to project the plurality of subchannel components (i.e., a received signal y) onto a subspace that is substantially orthogonal to at least one interference subspace.

FIG. 2E shows an embodiment of an interference canceller, including an interference projector 290 (i.e., a projection canceller), an interference selector 291, an optional combiner 292, and a demodulator/decision module 293. One or more projection operators in the interference projector 290 are generated with respect to an interference space selected by the interference selector 291. The interference selector 291 may utilize measurements of received signals, channel estimates, known signaling structures in the transmissions, and/or blind adaptive techniques to select interference components for inclusion in the interference space. The combiner 292 may optionally combine two or more projected signals produced by the interference projector 290. The demodulator/decision module 293 determines the corresponding symbols values of the signals output by the interference projector 290 or the combiner 291. The interference selector 291 may use one or more signal-quality measurements to select or adapt the interference subspace. Signal-quality measurements include probability of error, BER, PER, FER, or the like at the demodulator/decision module 293 and/or SNR at the output of the interference projector 290 or the combiner 292.

Receiver embodiments of the invention may be used with time-division multiple access, code-division multiple access, space-division multiple access, frequency-division multiple access, and/or adaptive antenna array technologies. Frequency-domain receiver embodiments of the invention may be employed in single-carrier systems. For example, embodiments of the invention may be employed in systems in which direct-sequence codes provide coded data symbols with predetermined spectral profiles. While various direct-sequence codes have been developed to impart predetermined spectral profiles to transmitted signals, it is also pertinent to note that spread signals (and other wideband signals) may experience frequency-selective fading in a multipath environment. Thus, the task of ensuring that transmitted spreading codes are orthogonal in a multipoint-to-point or multipoint-to-multipoint system may be moot in a highly frequency-selective environment.

Some embodiments of the invention may estimate channel conditions for each link in order to select spreading codes. Other embodiments may employ adaptive feedback algorithms to adapt spreading codes relative to one or more measured signal-quality parameters at a receiver. Yet other embodiments may simply de-emphasize or ignore subchannels that are highly correlated. Thus, apparatus and method embodiments of the invention may transmit signals over the same frequency channels using linearly independent (orthogonal or non-orthogonal) sets of spreading codes and separate the encoded data via interference projection. Receiver embodiments of the invention may provide for separating received signals relative to any combination of spectral diversity and spatial diversity.

In some embodiments of the invention, a transmitter may employ diversity (e.g., spatial diversity and/or polarization diversity) to decorrelate otherwise highly correlated transmissions. This allows the transmitter to select spectral profiles (e.g., pulse shapes and/or spreading codes) that satisfy one or more alternative performance criteria, such as low peak-to-average power ratio (PAPR). For example, spectral shaping typically imposes a trade off between bandwidth efficiency and low PAPR. Similarly, techniques for reducing PAPR typically result in lower bandwidth efficiency and/or higher interference. In transmitters that employ multiple-access coding and pulse shaping, bandwidth efficiency can be related to the degree of orthogonality between multiplexing and/or multiple-access channels. For example, bandwidth efficiency may be compromised by ISI and MAI. Bandwidth efficiency is also related to the number of orthogonal channels supported by transmission signaling. As coding or pulse shaping is employed to reduce PAPR and/or achieve a steeper spectral roll-off, the number of orthogonal codes or pulse positions typically decreases.

FIG. 2F illustrates an embodiment of the invention that may achieve an advantageous balance between PAPR and bandwidth efficiency (e.g., throughput and/or capacity). Spectral shaping is performed 285, such as pulse shaping or coding, to generate a baseband transmission signal having a low PAPR. However, spectral shaping can result in overlap between some of the signal spaces (i.e., pulse shapes or codes). For example, adjacent pulses may overlap, resulting in ISI. Similarly, subsets of codes may be highly correlated with each other. Embodiments of the invention may advantageously employ signaling schemes that help shape the structure of ISI and/or MAI, such as to confine interference (e.g., resulting from channel effects) from each signal space to a subset of other signal spaces. Such non-uniform distributions of ISI and/or MAI can help reduce the complexity of multi-user detection.

Highly correlated, or overlapping, signal spaces may be decorrelated by employing some form of transmit diversity 287. For example, highly correlated transmissions may be routed to spatially separated antennas such that the propagation channel effectively decorrelates the signals. Similarly, correlated signals may be provided with different beam patterns or polarizations. One or more signal-quality parameters may optionally be measured 289 at a receiver. Signal-quality parameters may include SNR, BER, PER, FER, the number of interference vectors in matrix S, as well as other signal-quality measures. The measured signal-quality parameters may be fed back 290 and used to adapt the spectral shaping 285 and/or the transmit diversity 287. Some embodiments of the invention may provide for adapting spectral shaping 285 and/or transmit diversity 287 in order to improve or optimize one or more signal-quality parameters.

FIG. 2G shows a receiver embodiment of the invention that includes characterizing MAI and/or ISI 284 in a received baseband signal, followed by interference selection 286 and interference cancellation 288. A measured or analytically determined distribution of interference can be used in interference selection 286 to select interference vectors to be included in matrix S. For example, only strong interferers may be selected. Interference cancellation 288 comprises employing at least one projection operator to project the received baseband signal onto a subspace that is substantially orthogonal to an interference subspace. One or more signaling parameters, such as the aforementioned signal-quality parameters and/or signal-processing parameters (including interference vectors in matrix S, processing complexity, etc.) may be routed in an optional feedback loop 294. The feedback loop 294 may be adapted to control or adapt the MAI/ISI characterization 284 and/or the interference selection 286 in response to the signaling parameters.

III. Interference Cancellation for N-Point Transforms

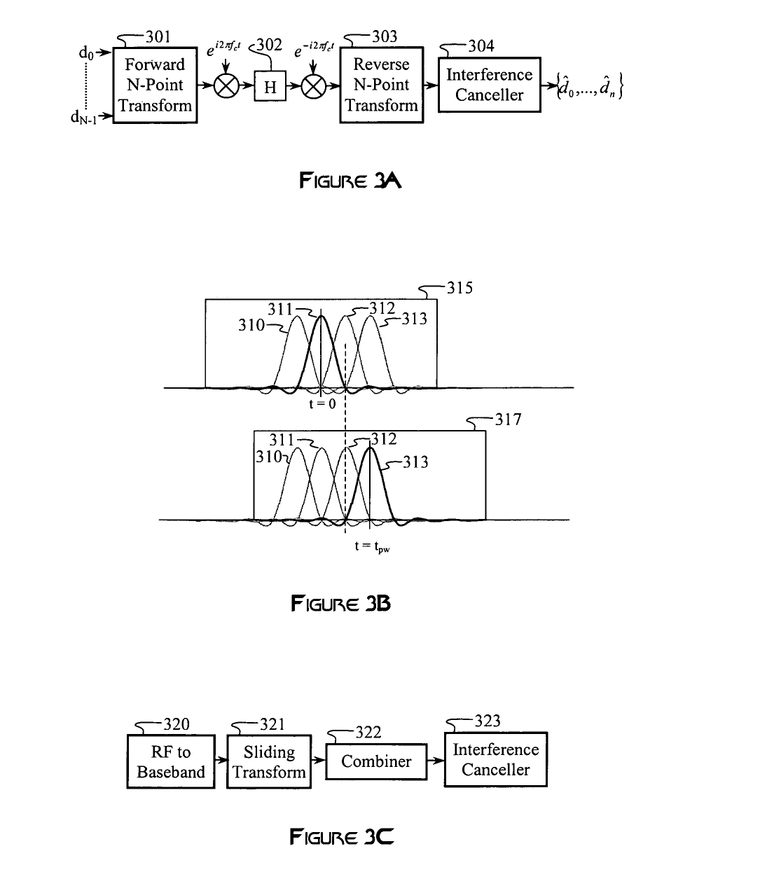

FIG. 3A illustrates an alternative embodiment of the invention in which data symbols d₀-d_{N-l} are provided to input bins of a forward N-point transform 301 prior to being frequency up-converted and transmitted into a communication channel 302. Various channel distortions, including fast fading, Doppler, frequency offsets, and phase noise, can cause a mismatch between the output bins of a reverse N-point transform 303 and the input bins of the forward N-point transform 301. These distortions typically cause dispersion of signal energy from each subchannel to one or more adjacent subchannels, such as described in T. Pollet, et al., “BER Sensitivity of OFDM Systems to Carrier Frequency Offset and Wiener Phase Noise,” IEEE, Trans. Comm., Vol. 43, No. 2/3/4, February/March/April 1995, pp. 191-193, and in X. Gui, et al., “Performance of Asynchronous Orthogonal Multicarrier CDMA System in Frequency Selective Fading Channel,” IEEE Trans. Comm., vol. 47, No. 7, July 1999, pp. 1084-1091. An interference canceller 304 produces estimated data symbols \hat{d}₀ to \hat{d}ₙ (where n≦N−1 for each symbol period Tₛ) by projecting sub-carrier symbols onto a subspace that is substantially orthogonal to an interference subspace.

In the case of a Fourier transform, the presence of impairments (e.g., fast fading, Doppler shifts, frequency offsets, and phase noise) causes the orthogonality between subcarriers to be lost. At a receiver, each subcarrier frequency bin may suffer from leakage from other subcarriers. This leakage disperses the energy of a particular subcarrier over the adjacent subcarriers. Method and apparatus embodiments of the present invention address these impairments via orthogonal projection interference cancellation. Interference cancellation can correct for frequency offsets, phase noise, Doppler, and fast fading, thereby mitigating the performance loss due to these factors. The following discusses the concepts underlying the receiver structure of one embodiment of the invention.

A transmitted signal xₖ(t) corresponding to a k^{th} data symbol dₖ or user is expressed by:

$${x}_{k} ( t ) = {d}_{k} {\sum }_{n = 0}^{N - 1} {a}_{n} q ( t ) {ⅇ}^{ⅈ2π {f}_{n} t}$$

where aₙ represents a frequency-domain spreading code (if any), and q(t) is the normalized pulse shape for a symbol interval Tₛ. A received signal rₖ(t) is expressed by:

$${r}_{k} ( t ) = {d}_{k} {\sum }_{n = 0}^{N - 1} {a}_{n} β ( t , {f}_{n} ) q ( t ) {ⅇ}^{ⅈ2π {f}_{n} t} + η ( t )$$

where β(t,fₙ)=h(t,fₙ)e^{i2πf}^{_{off}}^{t}e^{iQ(t)}. The term h(t,fₙ) represents the time-varying channel for subcarrier fₙ due to fast fading, e^{i2πf}^{_{off}}^{t} accounts for any frequency offset between the transmitter and the receiver, and e^{iQ(t)} indicates any phase noise.

Temporal variations in the channel coefficients are manifested as spectral dispersion, resulting in spectral spreading around each subcarrier frequency. The term βₙ(t,fₙ), which represents the part of β(t,fₙ) affecting a particular subcarrier, can be written as:

$${β}_{n} ( t , {f}_{n} ) = {\sum }_{m} {c}_{m , n} {ⅇ}^{ⅈ2π mt / {T}_{s}} ,$$

where each channel coefficient c_{m,n} is expressed by:

$${c}_{m , n} = \frac{1}{{T}_{s}} {\int }_{0}^{{T}_{s}} \overline{β} ( t , {f}_{n} ) {ⅇ}^{- ⅈ2π m t / {T}_{s}} ⅆ t$$

The general expression for c_{m,n} in the presence of frequency offset, phase noise, and a fast fading channel is:

$${c}_{m , n} = \frac{1}{{T}_{s}} {\int }_{- {B}_{d}}^{{B}_{d}} H ( θ , {f}_{n} ) K ( \frac{m}{{T}_{s}} - θ - {f}_{off} ) ⅆ θ where$$

$$H ( θ , {f}_{n} ) = {\int }_{0}^{{T}_{s}} h ( t , {f}_{n} ) {ⅇ}^{- ⅈ2πθ t} ⅆ t and K ( θ ) = {\int }_{0}^{{T}_{s}} {ⅇ}^{ⅈ Q ( t )} {ⅇ}^{- ⅈ2πθ t} ⅆ t$$

The received signal rₖ(t) can also be represented as:

$${r}_{k} ( t ) = {d}_{k} {\sum }_{n = 0}^{N - 1} {\sum }_{m = {M}_{1}}^{{M}_{k}} {a}_{n} {c}_{m , n} q ( t ) {ⅇ}^{ⅈ2π m t / {T}_{s}} {ⅇ}^{ⅈ2π {f}_{n} t} + η ( t )$$

where M₁ and Mₖ are integers that are determined by the imperfections in the received signal and the resulting distribution of interference. Thus, when imperfections are present, the transmitted information on a particular subcarrier also appears on one or more adjacent subcarriers as a result of spectral dispersion. In each case, the majority of interference energy is concentrated in a relatively small number of the coefficients c_{m,n} {m=M₁, . . . , Mₖ}. Thus, in accordance with several embodiments of the invention, interference vectors of matrix S are selected with respect to the strongest coefficients c_{m,n}.

The DFT of an OFDM signal having N subcarriers can be expressed by:

$${\hat{y}}_{n} = {c}_{nn} {d}_{n} + {{\sum }_{k = 1}^{N - 1}}_{k \neq n} {c}_{nk} {d}_{k}$$

where Cₙₙ is a scaling factor (such as resulting from the mapping of a Δn-offset subcarrier bearing data symbol dₙ onto the n^{th} frequency bin of the DFT) and c_{n,k≠n} represents cross-correlation interference terms. Noise in the signal ŷₙ is not shown. In OFDM, subcarriers that are within ±1 of n′ often provide the largest contribution of interference to the signal ŷₙ. This interference tends to diminish for subcarriers that are farther away from n′.

An expression for vector ŷ={ŷ₀, . . . , ŷ_{N-1}} can be written with respect to a vector subspace h corresponding to a data symbol of interest d₀ and an interference matrix S:

$$\hat{y} = \vert h S \vert \vert \begin{matrix}{d}_{0} \\ {d}_{1} \\ ⋮ \\ {d}_{N - 1}\end{matrix} \vert where h = \vert \begin{matrix}{α}_{0} \\ {c}_{10} \\ ⋮ \\ {c}_{( N - 1 ) 0}\end{matrix} \vert , and$$

$$S = \vert \begin{matrix}{c}_{01} & ⋯ & {c}_{0 ( N - 1 )} \\ ⋮ & & ⋮ \\ {c}_{( N - 1 ) 1} & ⋯ & {c}_{( N - 1 ) ( N - 1 )}\end{matrix} \vert$$

Thus, an estimated value \hat{d}₀ for data symbol d₀ can be generated by projecting the symbol values of ŷ onto a subspace that is substantially orthogonal to the interference subspace represented by matrix S:
\hat{d}₀=(h^{T}P_{S}^{⊥}h)⁻¹h^{T}P_{S}^{⊥}ŷ

In one exemplary embodiment, the interference vectors of matrix S are selected with respect to a measured and/or analytically determined interference structure in a signal of interest. The interference structure characterizes the nature of interference in a particular signal, such as previously described with respect to the spectral proximity (i.e., value n) of interfering subcarriers having a fractional Δn offset. For example, the interference structure associated with time, frequency, and/or phase offsets in an FFT may be dominated by leakage from adjacent sub-carrier tones, and sub-carrier tones that are farther away contribute substantially less interference. Thus, vectors of matrix S may be selected with respect to only nearby tones to effectuate an equitable trade-off between cancellation performance and processing complexity.

The interference structure in a received signal is typically characterized by the type of forward transform employed and the nature of channel distortions affecting the propagated signals. For example, a direct-sequence signal can be expressed by:

$$x ( t ) = Re \{ [ ( \frac{d ( t ) q ( t )}{{T}_{c}} comb ( \frac{t}{{T}_{c}} ) ) ⊗ {h}_{tx} ( t ) ] {e}_{tx} ( t ) \}$$

where d(t) represents the transmitted data, q(t) is the spreading sequence, T_{c} is the chip duration, hₜₓ(t) is an impulse response of a pulse-shaping filter, and eₜₓ(t)=e^{i2πf}^{_{c}}^{t} denotes the carrier wave. The convolution of the comb function

$$comb ( \frac{t}{{T}_{c}} ) = {\sum }_{n}^{} δ ( \frac{t}{{T}_{c}} - n )$$

with the pulse shape hₜₓ(t) generates a sequence of translated pulses modulated with data d(t) and spreading chips q(t). Thus, interference due to pulse overlap, such as resulting from multipath dispersion, may be caused by only a subset of previously transmitted symbols.

In block transforms, such as Fourier transforms, a transmitted signal may be expressed as a sequence of cyclically shifted waveforms having a period Tₛ equal to the transform block length. Thus, the interference structure (i.e., leakage pattern) of a block transform differs from that of a translated sequence in that waveform distortions occurring at one end of the block can interfere with waveforms at the other end of the block, such as described in U.S. Pat. Appl. Pub. 20040086027 (which is incorporated by reference).

Specific embodiments of the invention may compensate for structured interference resulting from the application of block (e.g., Fourier) transforms to sequential (i.e., non-cyclic) signals and/or linear operations to block-transform signals. For example, the reverse N-point transform 303 may employ a sliding transform, such as a sliding FFT.

FIG. 3B illustrates an exemplary application of a sliding transform embodiment of the invention. A modulated pulse sequence includes sequential (translated) modulated pulse waveforms 310-313. In this case, the pulse waveforms 310-313 take the form of root-raised cosines. Alternatively, other pulse shapes may be employed.

A first block transform window 315 is centered on pulse waveform 311 at time t=0. A block transform, such as a DFT, may provide a spectral characterization of the pulse waveform 311. In an alternative receiver embodiment, a matched filter and a sliding correlator may be employed. The matched filter may optionally be mapped to individual spectral components of the waveform's 311 pulse shape. However, other pulse waveforms (such as pulse waveforms 310, 312, and 313) within the block transform window 315 can contribute ISI to the spectral characterization of pulse waveform 311. This ISI can result from many factors, including multipath distortion of the pulse waveforms 310-313.

ISI resulting from mismatch between the pulse shapes of cyclically shifted waveforms in the block transform and the sequence of translated pulses 310-313 can be substantially reduced by employing a sliding transform centered on each pulse or pulse group of interest. In the case of a DFT, frequency bins fₘ of the DFT corresponding to the block transform window 315 centered at time t=0 can be expressed by:

$${X}_{0} ( {f}_{m} ) = {\sum }_{n = 0}^{N - 1} {x}_{n} {ⅇ}^{ⅈ 2 π {nf}_{m} / N}$$

For a second translated (i.e., t=t_{pw}) pulse waveform (e.g., pulse waveform 313), a time-shifted second block transform window 317 is provided. A time-shifted DFT is expressed by:

$${X}_{{t}_{pw}} ( {f}_{m} ) = {\sum }_{n = 0}^{N - 1} {x}_{n + k} {ⅇ}^{- ⅈ2π {nf}_{m} / N}$$

where k is the number of samples shifted relative to the translation time t_{pw}. The time-shifted DFT can also be expressed by:

$${X}_{{t}_{pw}} ( {f}_{m} ) = ( {X}_{0} ( {f}_{m} ) + {\sum }_{κ = 0}^{k - 1} {x}_{N + κ} - {\sum }_{κ = 0}^{k - 1} {x}_{κ} ) {ⅇ}^{ⅈ 2 π {nf}_{m} / N}$$

where the terms x_{N+κ} are the k newly added samples resulting from the shift, and the terms x_{κ} represent k samples of X₀ that are not in the time-shifted block transform window 317. It should be appreciated that there are alternative expressions and means for implementing sliding transforms, such as sliding DFTs.

The reverse N-point transform 303 shown in FIG. 3A may comprise a sliding transform, such as a sliding DFT. Similarly, alternative receiver embodiments of the invention may incorporate other sliding signal-processing operations, such as a sliding correlator. In one set of receiver embodiments, a block transform centered at a first time produces a plurality of spectral components corresponding to linear combinations of interfering data symbols modulated onto pulse waveforms occurring in a first transform window. In one embodiment, the interference canceller 304 may be configured to perform a frequency-domain projection in which a vector of spectral components corresponding to each transform window is projected onto a subspace that is substantially orthogonal to at least one interference subspace.

In another embodiment, the interference canceller 304 may be configured to perform a time-domain projection with respect to each spectral component. For example, a spectral component of a first block transform typically comprises a different linear combination of interfering signals than the same spectral component corresponding to a second, time-shifted, block transform. A time-domain projection includes projecting a vector of spectral components corresponding to a plurality of time-shifted block transforms onto a subspace that is substantially orthogonal to at least one interference subspace.

In yet another embodiment of the invention, the interference canceller 304 may be configured to perform a combined time-domain and frequency-domain projection. For example, the interference canceller 304 may be adapted to project a vector of a plurality of spectral components corresponding to a plurality of time-shifted block transforms onto a subspace that is substantially orthogonal to at least one interference subspace.

FIG. 3C illustrates another receiver embodiment of the invention in which spectral components produced by a sliding transform 321 are combined 322 with respect to each of a plurality of time-shifted block transforms. The sliding transform 321 may optionally include an equalizer (not shown). A resulting combined signal corresponding to each time-shifted block transform represents a unique linear combination of interfering signals (i.e., data symbols modulated onto waveforms residing within the corresponding block transform window). An interference canceller 323 is configured to project a vector comprising a plurality of the combined signals onto a subspace that is substantially orthogonal to at least one interference subspace. An interference selector (not shown) in the interference canceller 323 may be adapted to select a predetermined number of adjacent pulse positions as interference subspaces. The nature of the transmission (e.g., spectral and/or temporal power distribution in the transmitted signal), as well as multipath effects (delay spread or spectral-fading profile), can provide the basis for selecting interference vectors in matrix S.

IV Interference Cancellation in Equalizer Systems

In another embodiment of the invention, a receiver is further adapted to equalize the received signal y. Equalization usually takes the form:
(H^{H}H)⁻¹H^{H}y=(H^{H}H)⁻¹H^{H}HGd≈Gd
and is typically performed prior to despreading or performing some other reverse transform (e.g., the application of a despreading operator (G^{H}G)⁻¹G^{H}). While equalization can mitigate some of the distortion caused by the channel, it seldom removes all of the ISI and/or MAI. In practice, equalization is not perfect. This is especially true when transmissions in a multipath environment fail to provide an adequate guard interval between sequential symbols. Thus, the benefit of frequency diversity via spreading often includes a penalty of increased ISI and/or MAI. Furthermore, it may be advantageous to avoid fully equalizing deeply faded subcarriers to avoid increasing the noise floor of the received signal. In OFDM, it is common to ignore deeply faded subcarriers. The resulting loss of subcarrier terms causes ISI and/or MAI in orthogonal spread-OFDM signals.

In practice, equalization can be expressed by:
y_{eq}=(Ĥ^{H}Ĥ)⁻¹Ĥ^{H}y=(Ĥ^{H}Ĥ)⁻¹Ĥ^{H}HGd=H_{Î}Gd
where the term H_{Î} represents a less than perfect identity matrix. Thus, the application of the despreading operator (G^{H}G)⁻¹G^{H} to the “equalized” signal y_{eq} results in some interference between the data symbols dₙ. A preliminary estimate ŷₙ for each data symbol dₙ is provided by despreading y_{eq} with respect to an n^{th} despreading vector operator:

$${\hat{y}}_{n} = {α}_{n} {d}_{n} + {c}_{nn} {d}_{n} + {\sum }_{{k = 0}_{k \neq n}}^{N - 1} {c}_{nk} {d}_{k} + η$$

where αₙ is a channel scaling factor, cₙₙ represents any self-interference, c_{n,k≠n} represents cross-correlation interference terms, and η represents additive noise. The self-interference term cₙₙ can occur as a result of multipath-delayed versions of a desired symbol. Otherwise, both the channel scaling factor αₙ and the self-interference term cₙₙ can be expressed by term cₙₙ.

An expression for vector ŷ={ŷ₀, . . . , ŷ_{N-1}} can be written with respect to a vector subspace h corresponding to a data symbol of interest d₀ and an interference matrix S:

$$\hat{y} = \vert \begin{matrix}h & S\end{matrix} \vert \vert \begin{matrix}{d}_{0} \\ {d}_{1} \\ ⋮ \\ {d}_{N - 1}\end{matrix} \vert$$

$$where$$

$$h = \vert \begin{matrix}{c}_{00} \\ {c}_{10} \\ ⋮ \\ {c}_{( N - 1 ) 0}\end{matrix} \vert , and S = \vert \begin{matrix}{c}_{01} & ⋯ & {c}_{0 ( N - 1 )} \\ ⋮ & & ⋮ \\ {c}_{( N - 1 ) 1} & ⋯ & {c}_{( N - 1 ) ( N - 1 )}\end{matrix} \vert$$

Thus, an estimated value \hat{d}₀ for data symbol d₀ can be generated by projecting the symbol values of ŷ onto a subspace that is substantially orthogonal to the interference subspace represented by matrix S:
\hat{d}₀=(h^{T}PSₛ^{⊥}h)⁻¹h^{T}P_{S}^{⊥}ŷ

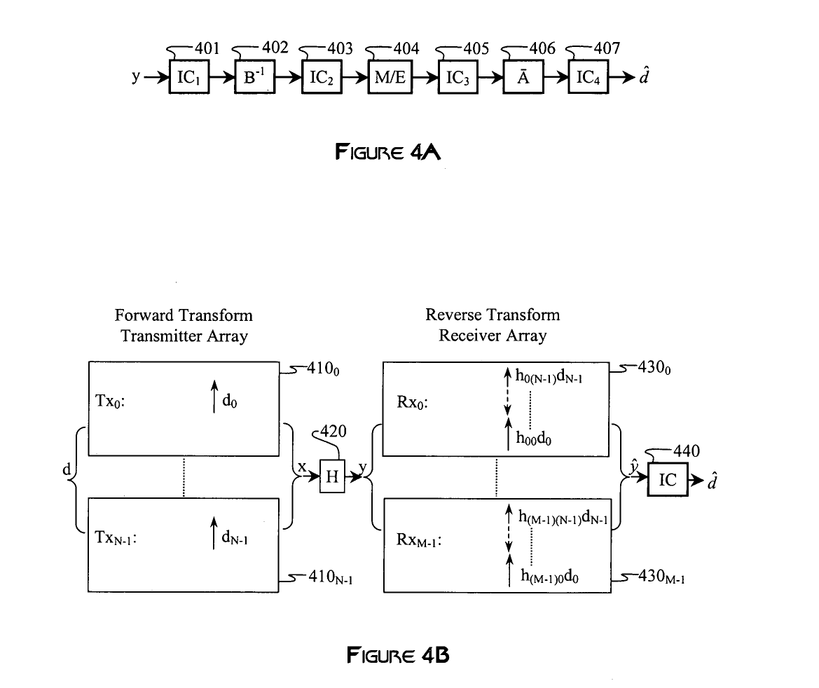

FIG. 4A illustrates a set of receiver embodiments of the invention. A transmitted signal is frequency down-converted and sampled to provide a received digital baseband signal y. Optional interference cancellation 401 (such as by projecting the symbol values of y onto a subspace that is substantially orthogonal to an interference subspace S) may be performed prior to an invertible transform operation 402. A similar type of orthogonal projection may be employed to provide interference cancellation 403 before an optional equalizer 404. Similarly, interference cancellation via orthogonal projection may optionally be performed before 405 and/or after 407 despreading 406.

In some embodiments of the invention, vectors in the interference matrix S are selected with respect to one or more predetermined relationships between interfering signals and the signal(s) of interest. For example, a number M of the strongest interferers of a group of interfering signals may be canceled. The number M may be selected as a predetermined number or as the number of interferers exceeding a predetermined power threshold. Thus, some measurement of the channel conditions may be included in the construction of the interference matrix S.

Embodiments of the invention may also account for similarities between the desired and interfering signals. In particular, it may be advantageous to avoid fully canceling interfering signals that map onto substantially the same signal subspace as a signal of interest. Embodiments of the invention may also utilize statistical information about the interference to determine the number M and/or select which interfering signals to cancel. For example, some spreading codes result in non-uniform distributions of interference to data symbols and/or users, especially in the presence of particular types of channel distortions. Some of these spreading codes are described in PCT Appl, No. PCT/US01/50856, which is hereby incorporated by reference. Thus, information about spreading and interference distribution may be used in a receiver to provide an equitable trade off between interference-cancellation performance and processing load.

Method and apparatus embodiments of the invention are provided for structuring interference, such as to limit the number of S vectors and/or simplify S vector selection. Techniques for providing for structured interference include (but or not limited) to the following:
1. Employing direct-sequence codes having predetermined spectral distributions to avoid deep fades and/or interference.
2. Employing subcarrier selection at the transmitter to avoid deep fades and/or interference.
3. Employing multicarrier spreading codes that localize in time (t<Tₛ) each spread data symbol. This can limit inter-code interference to adjacent data symbols.
4. Employing channel preceding.
5. Employing diversity transmission and/or reception. For example, antenna switching at the receiver can select antenna/subcarrier combinations that provide optimal SNR. Array combining across spatial subchannels can also optimize SNR for each subcarrier.
   V. Interference Cancellation in SDMA Transforms

In a receiver comprising M receiver antennas, up to M interfering signals can be separated. For example, a received signal vector ŷ={ŷ₀, . . . , ŷ_{N-1}} representing baseband symbols received across the M antennas for a particular flat-fading sub-channel frequency fₙ can be expressed by:

$$\begin{matrix}{\hat{y}}_{0} = {h}_{00} {d}_{0} + {\sum }_{n = 1}^{N - 1} {h}_{0 n} {d}_{n} \\ ⋮ \\ {\hat{y}}_{M - 1} = {h}_{( M - 1 ) 0} {d}_{0} + {\sum }_{n = 1}^{N - 1} {h}_{( M - 1 ) n} {d}_{n}\end{matrix}$$

where the terms hₘₙ represent complex-valued channel weights resulting from channel distortions. Similarly, transmitter-side spreading may be incorporated into the channel matrix terms hₘₙ. The values dₙ {n=0, . . . , N−1} correspond to a transmitted data vector d having up to N values transmitted by N transmitters.

The expression for vector ŷ with respect to a symbol of interest d₀ can be expressed as:

$$\vert \begin{matrix}{\hat{y}}_{0} \\ ⋮ \\ {\hat{y}}_{M - 1}\end{matrix} \vert = \vert \begin{matrix}{h}_{00} & {h}_{01} … {h}_{0 ( N - 1 )} \\ ⋮ & ⋮ \\ {h}_{( M - 1 ) 0} & {h}_{( N - 1 ) 1} … {h}_{( N - 1 ) ( N - 1 )}\end{matrix} \vert \vert \begin{matrix}{d}_{0} \\ {d}_{1} \\ ⋮ \\ {d}_{N - 1}\end{matrix} \vert$$

where the terms in the first matrix column hₘ₀ are scalar values and the terms shown in the second matrix column are intended to convey vectors for N>2. Similarly, d₀ represents a symbol value of interest in data vector d, and d_{1, . . . ,N-1} represents the other potentially interfering values in the data vector d.

The expression for vector ŷ can also be written with respect to a vector subspace h corresponding to the data symbol of interest d₀ and an interference subspace S:

$$\hat{y} = \vert \begin{matrix}h & S\end{matrix} \vert \vert \begin{matrix}{d}_{0} \\ {d}_{1} \\ ⋮ \\ {d}_{N - 1}\end{matrix} \vert$$

$$where$$

$$h = \vert \begin{matrix}{h}_{00} \\ {h}_{10} \\ ⋮ \\ {h}_{( M - 1 ) 0}\end{matrix} \vert , and S = \vert \begin{matrix}{h}_{01} & ⋯ & {h}_{0 ( N - 1 )} \\ ⋮ & & ⋮ \\ {h}_{( M - 1 ) 1} & ⋯ & {h}_{( M - 1 ) ( N - 1 )}\end{matrix} \vert$$

Although the interference subspace S is shown as a matrix, it may be approximated via a linear combination of interference vectors, such as is well known in the art. An estimated value \hat{d}₀ for data symbol d₀ can be generated by projecting the symbol values of ŷ₀ onto a subspace that is substantially orthogonal to the interference subspace S:
\hat{d}₀=(h^{T}P_{S}^{⊥}h)⁻¹h^{T}P_{S}^{⊥}ŷ
The term P_{S}^{⊥} is a projection operator that projects a predetermined input onto a subspace that is substantially orthogonal to S.

FIG. 4B illustrates a multiple-input/multiple-output communication system in which an array of N transmitters 410₀-410_{N-1} is configured for transmitting a plurality (up to N) of data symbols d₀, . . . , d_{N-1} into a communication channel 420. A process of coupling the data symbols d₀, . . . , d_{N-1} from the transmitter array 410₀-410_{N-1} into the channel 420 can be regarded as a forward transform operation.

A receiver array (i.e., receivers 430₀-430_{M-1}) that couples transmitted signals from the channel 420 can be regarded as performing a reverse transform on received signals y to produce the received signal vector ŷ={ŷ₀, . . . , ŷ_{M-1}}. Each value of ŷ represents a linear combination of the transmitted data symbols d₀, . . . , d_{N-1}. If there are M≧N linearly independent combinations of data symbols d₀, . . . , d_{N-1}, then an interference canceller 440 can explicitly solve for one or more of the data symbols by projecting the received signal vector ŷ onto a subspace that is orthogonal to an interference subspace constructed from the other interfering signals. Furthermore, destructive interference in the received signals can automatically remove or significantly reduce at least some of the interfering signals, thus simplifying interference selection and projection complexity. An interference selector (not shown) within the interference canceller 440 may exploit channel estimates and/or measured interference to select interference vectors in S to achieve a predetermined signal-quality threshold and/or provide for an equitable trade off between processing complexity and performance.

VI. Interference Cancellation in Space-Frequency Transforms

In another embodiment of the invention, signals spread across N frequencies and received by M antenna elements may support up to N·M linearly independent channels. In this case, the received signal is an M×N matrix ŷ={ŷ₀₀, . . . , ŷ_{(M-1)(N-1)}} representing received baseband symbols across the M antennas and N flat-fading subchannels fₙ {n=0, . . . , N−1}. A particular received signal ŷₘₙ corresponding to an m^{th} antenna and an n^{th} frequency can be expressed by:

$${\hat{y}}_{mn} = {\sum }_{k = 0}^{K - 1} {c}_{k} ( m , n ) {d}_{k} + η$$

where the terms cₖ(m,n) represent complex-valued scaling factors and K is the number of data symbols received in a particular symbol period Tₛ. Typically, K≦M·N. Each term cₖ(m,n) can be written as:
cₖ(m,n)=α_{m,n}Gₖ(fₙ)
where α_{m,n} denotes a complex value characterizing the effect of multipath on the n^{th} subcarrier frequency fₙ at the m^{th} receiver antenna, and Gₖ(fₙ) is the frequency-domain spreading chip applied by a transmitter to the k^{th} data symbol dₖ at the n^{th} subcarrier frequency fₙ.

In one aspect of the invention, data symbols d may be transmitted without frequency-domain spreading Gₖ(f). Such transmissions may include either or both single-carrier and multicarrier transmissions. Thus, linearly independent combinations of interfering signals at a receiver may be provided solely by the term α_{m,n}. Alternatively, different transmitters may employ the same frequency-domain spreading codes Gₖ(f). Similarly, linear independence in the combinations of interfering signals in this embodiment may also depend solely on the multipath term α_{m,n}. In another embodiment of the invention, transmissions may be provided with different frequency-domain spreading codes Gₖ(f).

In yet another embodiment of the invention, transmitted data symbols dₖ are provided with spectral profiles that can be processed at a receiver in substantially the same way as received signals encoded with frequency-domain spreading codes Gₖ(f). The invention may provide for transmission coding, such as direct sequence coding, that provides different spectral profiles with respect to the transmitted data symbols dₖ. For example, the invention may employ any of various single-carrier signals, including a CDMA signal, a WCDMA signal, a UMTS signal, and a GPS signal.

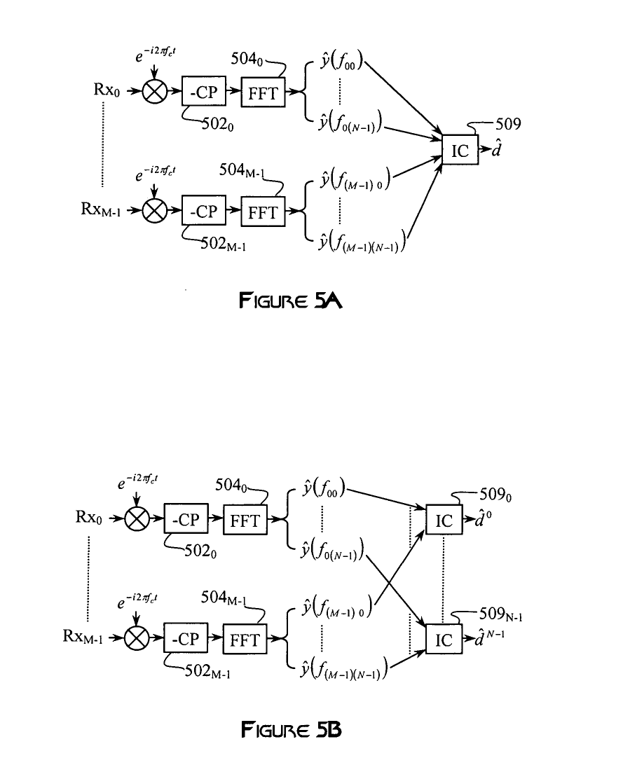

FIG. 5A illustrates an exemplary receiver embodiment wherein a reverse transform is implemented via receiving transmitted signals with an M-element array and separating the received signals into spectral components by a plurality of FFTs 504₀-504_{M-1}. In the case wherein transmitted signals include a cyclic prefix or guard interval, optional cyclic prefix removers 502₀-502_{M-1} may be employed.

Each of the plurality of received signal values ŷ={ŷ₀₀, . . . , ŷ_{(M-1)(N-1)}} represents a linear combination of the transmitted data symbols d₀, . . . , d_{K}. An interference canceller 509 is configured to project the received signal vector ŷ onto a subspace that is orthogonal to an interference subspace constructed from the other interfering signals. An interference selector (not shown) within the interference canceller 509 may exploit channel estimates and/or measured interference to select interference vectors in S to achieve a predetermined signal-quality threshold and/or provide for an equitable trade off between processing complexity and performance.

The interference canceller 509 may take various forms, such as the interference-canceller network 509₀-509_{N-1} shown in FIG. 5B. The interference cancellers 509₀-509_{N-1} are configured to project a vector of received subcarrier values ŷ={ŷ(fₙ₀), . . . , ŷ(f_{n(M-1)})} corresponding to at least one common frequency fₙ onto a subspace that is orthogonal to an interference subspace. In one embodiment, the interference cancellers 509₀-509_{N-1} are configured to perform beamforming in each of the frequency-domain subspaces fₙ. Thus, estimated data vectors \hat{d}ⁿ may correspond to data symbols mapped onto a plurality of spatial subspaces corresponding to subcarrier frequency fₙ.

In one embodiment of the invention, a combiner (not shown) or an additional canceller (not shown) may be coupled to outputs of the interference cancellers 509₀-509_{N-1} and configured to combine the estimated data vectors \hat{d}ⁿ, such as for diversity combining, multicarrier despreading, and/or interference cancellation. It should be appreciated that various embodiments of the invention may be adapted to separate received signals based on spatial diversity, frequency spectrum diversity, and combined spatial/spectral diversity.

VII. Interference Cancellation in a Spatial Diversity Rake Receiver

In a multipath channel, a received signal can be characterized by:

$$y ( t ) = {\sum }_{l = 0}^{L - 1} {α}_{l} x ( t - {τ}_{l} ) + η ( t )$$

where L is the number of received signal paths, x(t) is the transmitted signal, α₁ is the path strength, τ₁ is the path delay, and η(t) is additive noise. The transmitted signal x(t)=Ad comprises a sequence of data bits d={d₀, . . . , d_{K-1}} spread by a K×K spreading matrix A. Alternative embodiments may employ matrices A having different sizes.

If the value d₀ is designated as a first data symbol of interest, the received signal can be expressed by:

$$y ( t ) = {\sum }_{l = 0}^{L - 1} {α}_{l} {a}_{0} ( t - {τ}_{l} ) {d}_{0} + {\sum }_{l = 0}^{L - 1} {α}_{l} {\sum }_{k = 1}^{K - 1} {a}_{k} ( t - {τ}_{l} ) {d}_{k} + η ( t )$$

A received baseband signal may be produced by despreading the received signal y(t) with a relative time offset despreading code, such as a′₀(τₗ_{₁}) corresponding to the first symbol of interest d₀. Either the received signal y(t) or the despreading code a′₀ may be provided with time offsets to match the delay of individual multipath components. Each time offset τₘ preferably corresponds to a strong received multipath component of the transmitted signal x(t).

Multipath delays in the transmitted signals may cause loss of orthogonality between different time-offset codes at a receiver. For example, a first received baseband signal corresponding to a first (m=0) Rake finger delay τₗ_{₀} is given by:

$${\hat{y}}_{0} = {f}_{0} ( {τ}_{{l}_{0}} ) y = {α}_{0} {d}_{0} + {c}_{00} {d}_{0} + {\sum }_{k = 1}^{N - 1} {c}_{0 k} {d}_{k}$$

where the symbol of interest d₀ is scaled by a complex-valued channel-response term α₀ related to the strength of the τₗ_{₀} path, the term c₀₀ represents self interference resulting from time-offset correlations of a′₀(τₗ_{₀})a₀(t), and the terms c_{0,k≠0}=a′₀(τₗ_{₀})a_{k≠0}(t) represent ISI corresponding to time-offset cross-correlations of the despreading code a′₀ (τₗ_{₀}) with the other codes a_{k≠0}(t). Furthermore, dispersion in the propagation environment can cause earlier transmitted symbols to interfere with the current received symbols. Thus, this type of ISI may also be included, such as with respect to the terms c_{0,k≠0}.

An M^{th} (m=M−1) received baseband signal corresponding to an M^{th} Rake finger delay τₗ_{_{M−1}} is given by:

$${\hat{y}}_{M - 1} = {α}_{M - 1} {d}_{0} + {c}_{( M - 1 ) ( M - 1 )} {d}_{0} + {\sum }_{k = 1}^{N - 1} {c}_{( M - 1 ) k} {d}_{k}$$

where the symbol of interest d₀ is scaled by a complex-valued channel-response term α_{M-1} related to the strength of the τₗ_{_{M−1}} path, the term c_{(M-1)(M-1)} represents self interference resulting from time-offset correlations of a′₀(τₗ_{_{M−1}})a₀(t), and the terms c_{(M-1),k≠0} represent ISI corresponding to time-offset cross-correlations of the despreading code a′₀(τₗ_{_{M−1}}) with the other codes a′₀(τₗ_{_{M−1}})aₖ(t).

Each Rake finger may experience a unique linear combination of interfering terms. Thus, the values of vector ŷ={ŷ₀, . . . , ŷ_{M-1}} may constitute up to M linearly independent combinations of interference. In one embodiment of the invention, an antenna array is employed wherein each array element may experience a different received multipath delay profile. The advantageous combination of a plurality P of receiver antennas with Rake receivers having M fingers each comprises a reverse transform that provides up to M·P linearly independent combinations.

For each Rake receiver, the expression for vector ŷ with respect to the symbol of interest d₀ can be expressed as:

$$\vert \begin{matrix}{\hat{y}}_{0} \\ ⋮ \\ {\hat{y}}_{N - 1}\end{matrix} \vert = \vert \begin{matrix}{α}_{0} + {c}_{00} & {c}_{01} … {c}_{0 ( N - 1 )} \\ ⋮ & ⋮ \\ {α}_{M - 1} + {c}_{( M - 1 ) ( M - 1 )} & {c}_{( M - 1 ) 1} … {c}_{( M - 1 ) ( N - 1 )}\end{matrix} \vert \vert \begin{matrix}{d}_{0} \\ {d}_{1} \\ ⋮ \\ {d}_{N - 1}\end{matrix} \vert$$

where the terms in the first matrix column are scalar values and the terms in the second matrix column are intended to convey vectors for N>2. Terms in the data symbol vector d include the symbol of interest d₀ and the terms d_{1, . . . ,N-1}, which represent the potentially interfering values in vector d.

The expression for vector ŷ can also be written with respect to a vector subspace h corresponding to the data symbol of interest d₀ and an interference subspace S:

$$\hat{y} = \vert \begin{matrix}h & S\end{matrix} \vert \vert \begin{matrix}{d}_{0} \\ {d}_{1} \\ ⋮ \\ {d}_{N - 1}\end{matrix} \vert$$

$$where$$

$$h = \vert \begin{matrix}{α}_{0} + {c}_{00} \\ ⋮ \\ {α}_{M - 1} + {c}_{( M - 1 ) ( M - 1 )}\end{matrix} \vert , and S = \vert \begin{matrix}{c}_{01} & ⋯ & {c}_{0 ( N - 1 )} \\ ⋮ & & ⋮ \\ {c}_{( N - 1 ) 1} & ⋯ & {c}_{( N - 1 ) ( N - 1 )}\end{matrix} \vert$$

An estimated value \hat{d}₀ for data symbol d₀ can be generated by projecting the vector ŷ onto a subspace that is substantially orthogonal to the interference subspace S:
\hat{d}₀=(h^{T}P_{S}^{⊥}h)⁻¹h^{T}P_{S}^{⊥}ŷ
The term P_{S}^{⊥} is a projection operator that projects ŷ onto a subspace that is substantially orthogonal to S.

In some receiver embodiments of the invention, the interference subspace is selected from measured interference and/or analytically determined interference distributions. In one Rake receiver embodiment, the delay spread of the received signals is measured, and then the strongest contributors to the interference subspace may be determined analytically. For example, a Rake searcher finger may be employed to determine the magnitude and delay for each of a predetermined set of strongest multipath signals. In one embodiment, the number of selected interference components may be limited to those that exceed a predetermined received power threshold. In another embodiment, the number of selected interference components may be limited by the number of Rake fingers.

In other receiver embodiments, the amount of delay for individual multipath components may be used as a selection criterion for selecting interference components to be included in the interference subspace. In one embodiment, multipath components having delays that fall within one or more predetermined delay ranges may be selected. Receiver embodiments may employ one or more delay thresholds and provide for the selection of interference components having multipath delays that meet or exceed a minimum-delay threshold. Similarly, a receiver embodiment may provide for selecting one or more interference components having multipath delays that are at or below a maximum-delay threshold.

Receiver embodiments of the invention may employ combinations of signal strength and multipath delay criteria. In one exemplary embodiment, the interference subspace is selected from interference components that satisfy separate signal strength and multipath delay criteria. In an alternative receiver embodiment, signal strength and multipath delay criteria may be coupled. For example, different delay criteria may be used with respect to received multipath signals having different measured signal strengths. Similarly, the signal-strength criteria may vary with respect to measured multipath delay. Alternatively, signal strength and multipath delay may be provided with associated weights wherein a predetermined weight threshold may be used to select which interference components to include in the interference subspace.

In a multi-antenna Rake receiver, a received signal y^{p}(t) at a p^{th} antenna can be expressed by:

$${y}^{p} ( t ) = {\sum }_{l = 0}^{L - 1} {α}_{l}^{p} x ( t - {τ}_{l}^{p} ) + η ( t )$$

where L is the number of received signal paths, x(t) is the transmitted signal, αₗ^{p} is the path strength of the l^{th} path delay to antenna p, τₗ^{p} is the l^{th} path delay to antenna p, and η(t) is additive noise. The transmitted signal x(t) may comprise a sequence of data bits d={d₀, . . . , d_{K-1}} spread by a spreading matrix A.

If the value d₀ is designated as a first data symbol of interest, the received signal at antenna p=0 can be expressed by:

$${y}^{0} ( t ) = {\sum }_{l = 0}^{L - 1} {α}_{l}^{0} {a}_{0} ( t - {τ}_{l}^{0} ) {d}_{0} + {\sum }_{l = 0}^{L - 1} {α}_{l}^{0} {\sum }_{k = 1}^{K - 1} {a}_{k} ( t - {τ}_{l}^{0} ) {d}_{k} + η ( t ) ,$$

and the received signal at antenna p=(P−1) can be expressed by:

$${y}^{P - 1} ( t ) = {\sum }_{l = 0}^{L - 1} {α}_{l}^{P - 1} {a}_{0} ( t - {τ}_{l}^{P - 1} ) {d}_{0} + {\sum }_{l = 0}^{L - 1} {α}_{l}^{P - 1} {\sum }_{k = 1}^{K - 1} {a}_{k} ( t - {τ}_{l}^{P - 1} ) {d}_{k} + η ( t )$$

For each p={0, . . . , (P−1)} antenna, each m={0, . . . , (M−1)} finger of the antenna's associated Rake receiver may be followed by a despreader. A received baseband signal ŷₘ^{p} may be produced by despreading the received signal y^{p}(t) with a relative time offset τₗ^{p} despreading code, such as a′₀(τₗ^{p}) corresponding to the first symbol of interest d₀.

The resulting baseband signals corresponding to despreading code a′₀(τₗ^{p}) are:

$$\begin{matrix}{\hat{y}}^{0} = \vert \begin{matrix}{\hat{y}}_{0}^{0} = {α}_{0}^{0} {d}_{0} + {c}_{00}^{0} {d}_{0} + {\sum }_{k = 1}^{N - 1} {c}_{0 k}^{0} {d}_{k} \\ ⋮ \\ {\hat{y}}_{M - 1}^{0} = {α}_{M - 1}^{0} {d}_{0} + {c}_{( M - 1 ) ( M - 1 )}^{0} {d}_{0} + {\sum }_{k = 1}^{N - 1} {c}_{( M - 1 ) k}^{0} {d}_{k}\end{matrix} \vert \\ ⋮ \\ {\hat{y}}^{P - 1} = \vert \begin{matrix}{\hat{y}}_{0}^{P - 1} = {α}_{0}^{P - 1} {d}_{0} + {c}_{00}^{P - 1} {d}_{0} + {\sum }_{k = 1}^{N - 1} {c}_{0 k}^{P - 1} {d}_{k} \\ ⋮ \\ {\hat{y}}_{M - 1}^{P - 1} = {α}_{M - 1}^{P - 1} {d}_{0} + {c}_{( M - 1 ) ( M - 1 )}^{P - 1} {d}_{0} + {\sum }_{k = 1}^{N - 1} {c}_{( M - 1 ) k}^{P - 1} {d}_{k}\end{matrix} \vert\end{matrix}$$

The expression for vector ŷ with respect to the data symbol of interest d₀ is:

$$\hat{y} = \vert \begin{matrix}{\hat{y}}^{0} \\ ⋮ \\ {\hat{y}}^{P - 1}\end{matrix} \vert = \vert \begin{matrix}[ {h}^{0} , {s}^{0} ] \\ ⋮ \\ [ {h}^{P - 1} , {s}^{P - 1} ]\end{matrix} \vert \vert \begin{matrix}{d}_{0} \\ {d}_{1} \\ ⋮ \\ {d}_{N - 1}\end{matrix} \vert = \vert \begin{matrix}h & S\end{matrix} \vert \vert \begin{matrix}{d}_{0} \\ {d}_{1} \\ ⋮ \\ {d}_{N - 1}\end{matrix} \vert$$

$$where \\$$

$${h}^{p} = \vert \begin{matrix}{α}_{0}^{p} + {c}_{00}^{p} \\ ⋮ \\ {α}_{M - 1}^{p} + {c}_{( M - 1 ) ( M - 1 )}^{p}\end{matrix} \vert , and {S}^{p} = \vert \begin{matrix}{c}_{01}^{p} & ⋯ & {c}_{0 ( N - 1 )}^{p} \\ ⋮ & & ⋮ \\ {c}_{( N - 1 ) 1}^{p} & ⋯ & {c}_{( M - 1 ) ( M - 1 )}^{p}\end{matrix} \vert$$

for a p^{th} antenna. The expression for vector ŷ can also be written with respect to a vector subspace h corresponding to the data symbol of interest d₀ and an interference subspace S:

$$\hat{y} = \vert \begin{matrix}h & S\end{matrix} \vert \vert \begin{matrix}{d}_{0} \\ {d}_{1} \\ ⋮ \\ {d}_{N - 1}\end{matrix} \vert$$

$$where$$

$$h = \vert \begin{matrix}{h}^{0} \\ ⋮ \\ {h}^{P - 1}\end{matrix} \vert , and S = \vert \begin{matrix}{S}^{0} \\ ⋮ \\ {S}^{P - 1}\end{matrix} \vert$$

Thus, an estimated value \hat{d}₀ for data symbol d₀ can be generated by projecting the vector ŷ onto a subspace that is substantially orthogonal to the interference subspace S:
\hat{d}₀=(h^{T}P_{S}^{⊥}h)⁻¹h^{T}P_{S}^{⊥}ŷ
where the term P_{S}^{⊥} is a projection operator that projects ŷ onto a subspace that is substantially orthogonal to S, and h^{T} functions as a diversity combiner. There are many alternative embodiments to the multi-antenna Rake receiver described herein.

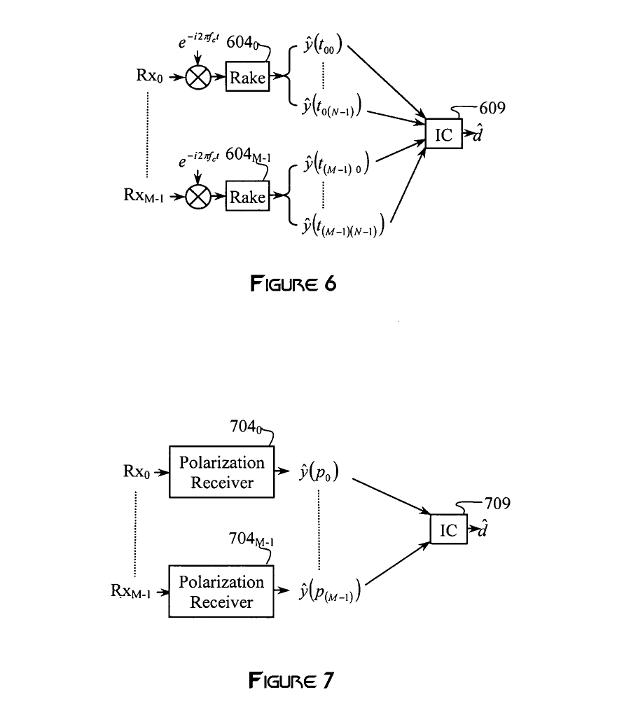

FIG. 6 illustrates an exemplary receiver embodiment wherein a reverse transform is implemented via receiving transmitted signals with an M-element array and separating received signals Rx₀-Rx_{M-1} into delay-spread components by a plurality of Rake receivers 604₀-604_{M-1}. Each Rake receivers 604₀-604_{M-1} may include at least one despreader (not shown). The plurality of received signal values ŷ={ŷ₀₀, . . . , ŷ_{(M-1)(N-1)}} each represents a linear combination of the transmitted data symbols d₀, . . . , d_{K}.

An interference canceller 609 is configured to project the received signal vector ŷ onto a subspace that is orthogonal to an interference subspace constructed from interfering signals. An interference selector (not shown) within the interference canceller 609 may exploit channel estimates and/or measured interference to select interference vectors in S to achieve a predetermined signal-quality threshold and/or provide for an equitable trade off between processing complexity and performance.

FIG. 7 illustrates a receiver embodiment of the invention configured to provide a reverse transform via a plurality M of polarization receivers 704₀-704_{M-1}. The polarization receivers 704₀-704_{M-1} may be configured to have different relative responses to received polarized signals. The receivers 704₀-704_{M-1} may be sensitive to differently polarized signals in planar or spatial dimensions. The receivers 704₀-704_{M-1} may include orthogonal and/or non-orthogonally polarized receivers. Linear and/or circular polarizations may be employed. Thus, a plurality of received signal values ŷ={ŷ₀, . . . , ŷ_{(M-1)}} output from the receivers 704₀-704_{M-1} represents a linear combination of the transmitted data symbols d₀, . . . , d_{K}. An interference canceller 709 is configured to project the received signal vector ŷ onto a subspace that is orthogonal to an interference subspace constructed from the other interfering signals.

VIII. Interference Cancellation in Frequency-Hopped OFDM

In some OFDMA systems, neighboring base stations use different non-overlapping parts of the available spectrum and non-neighboring base stations may use the same parts of the available spectrum. Thus, there is little or no intra-cell interference between stationary users. However, the spectrum available for use in each cell is only a small part of the total available spectrum. Furthermore, the spectral-reuse pattern is based on worst-case inter-cell interference rather than average interference.

Various OFDMA systems adapted to average interference include (in order of increasing complexity) coded-OFDM, spread-OFDM (and MC-CDMA), and finally, frequency-hopped OFDM. U.S. Pat. No. 5,548,582 (which is incorporated by reference) describes a frequency-hopped OFDM system that employs fast and/or slow frequency hopping techniques adapted for processing with a Fourier transform. In frequency-hopped systems, each transmitter transmits a narrowband signal and periodically changes the carrier frequency to achieve the frequency hopping.

Frequency hopping spreads the selective effects of the transmission channel (e.g., multipath fading) over a larger group of subcarriers to improve the robustness and quality of the overall transmission channel (such as described in U.S. Pat. Nos. 6,377,566 and 5,425,049, which are incorporated by reference). It is also well known that interference averaging can advantageously exploit a network's traffic activity factor to improve frequency-reuse patterns and increase throughput and capacity. Furthermore, the combination of interference cancellation and frequency hopping can greatly enhance spectral reuse and increase throughput and capacity.

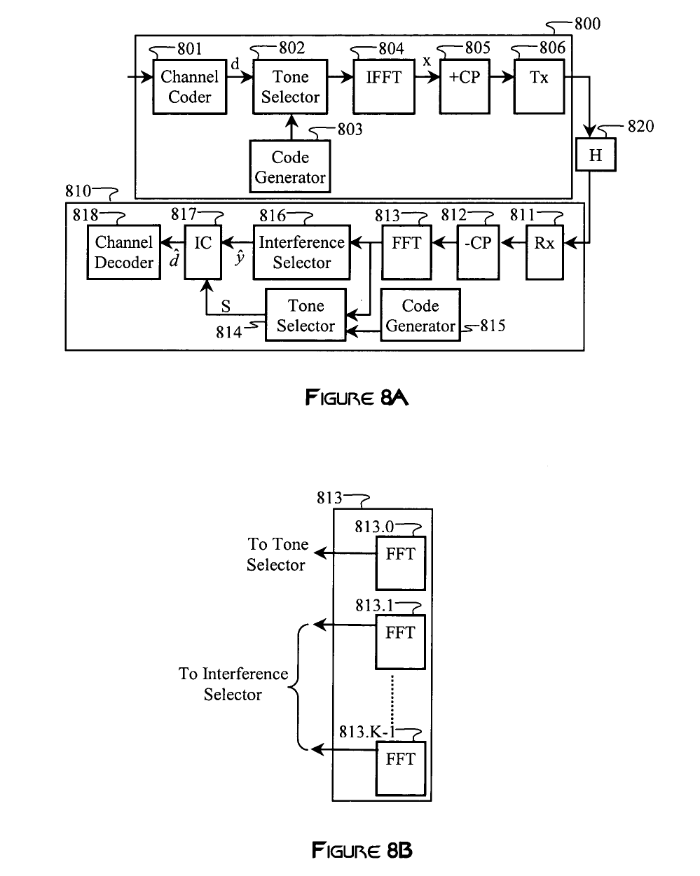

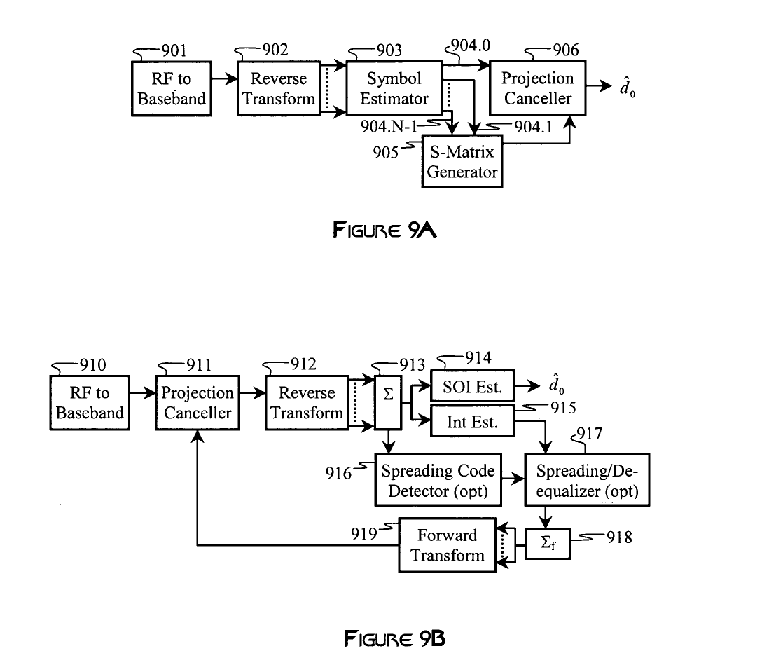

FIG. 8A shows a block diagram of an exemplary OFDM communication system, including a transmitter 800 and a receiver 810. The transmitter 800 comprises a channel coder 801, a tone selector 802 and a tone-selection code generator 803 coupled thereto, a tone generator (e.g., an IFFT 804), an optional cyclic prefix prepender 805, and an RF transmitter 806. The receiver 810 includes an RF receiver 811, an optional cyclic-prefix remover 812, a tone separator (e.g., an FFT 813), a tone selector 814 and a tone-selection code generator 815 coupled thereto, an interference selector 816, an interference canceller 817, and a channel decoder 818.

The channel coder 801 receives an information stream and encodes it relative to one or more predetermined coding schemes. The information stream typically includes information streams generated for more than one user if the transmitter 800 is used in a base station and an information stream for only one user if the transmitter 800 is used in a mobile terminal. The channel coder 801 employs an appropriate encoding scheme as a function of the type of information being transmitted, codes specified in a corresponding system protocol, spreading (if any), and/or the model of the interference environment in which the OFDM system is deployed.

The channel coder 801 may be configured to interleave the input information symbols or the coded output symbols. Thus, instead of the symbols generated by the channel coder 801 being transmitted sequentially, they are transmitted out of order in a manner that is preferably likely to facilitate error correction if some of the symbols are not received correctly due to interference.

The tone selector 802 assigns the encoded information stream(s) to one or more frequency bins of the IFFT 804 with respect to at least one hopping code provided by the code generator 803. The number of tones assigned to a particular user may depend on that user's bandwidth needs and may change over time.

The cyclic-prefix prepender 805 may add a cyclic prefix to each symbol period. The cyclic prefix may be added only for the tones being used by the OFDM transmitter 800. Thus, for example, if the OFDM transmitter 800 is in a base station using all of the tones, then the cyclic prefix uses all of the available orthogonal tones within the allocated bandwidth. If the OFDM transmitter 800 is in a mobile terminal, then the cyclic prefix includes only the subset of tones transmitted by the mobile terminal. The radio transmitter 806 provides any necessary signal processing to condition the baseband signal for transmission through a predetermined communication channel 820.

In the downlink, the system may employ slow hopping (i.e., one hop per one or more symbols) or fast hopping (i.e., more than one hop per symbol interval). Hopping patterns typically provide for frequency interleaving across a distribution of subcarriers that exceeds the channel's coherence bandwidth so that channel averaging is optimized. Similarly, the uplink may provide for slow or fast hopping. However, slow hopping is generally preferred in the uplink.

A signal received from the communication channel 820 by the RF receiver 811 is converted to a received digital baseband signal. The optional cyclic-prefix remover 812 removes the cyclic prefix from each period of the received signal. The remaining signal is coupled to the FFT 813, which extracts each information stream received on the various tones. The tone-selection code generator 815 assigns tones to be used by the OFDM receiver 810 and conveys those assignments to the tone selector 814. The interference selector 816 selects one or more tones corresponding to interfering signals and couples selected interfering signals into the interference canceller 817. The channel decoding is often performed according to the inverse of the scheme used to encode the information stream. However, modifications may be made to the decoding scheme to account for channel propagation and other effects to produce a more reliable decoded output than simply using the inverse of the encoding scheme.

The interference selector 816 may be configured to select a subset of interfering signals based on any of various parameters. For example, adjacent narrowband tones can be particularly susceptible to Doppler-shift interference in mobile networks. In embodiments employing spread-OFDM coding in combination with frequency hopping, certain spreading codes may be selected that map data symbol to pulse waveforms orthogonally positioned in time. Such spreading codes in combination with frequency hopping are well known in the art, as described in U.S. Pat. No. 6,686,879, which is incorporated by reference. Channel dispersion can cause ISI between such codes. However, the ISI is typically limited to adjacent code sets.

In some systems, hopping patterns are selected such that the interferers change between hops. If the hopping patterns of other users are known, or can at least be estimated, this can simplify the interference selection. Embodiments of the invention may be configured to select interference vectors with respect to predetermined hopping patterns, such as patterns that are a function of a mutually orthogonal Latin square. Such hopping patterns are well known in the art and described, for example, in U.S. Pat. Nos. 6,310,704, 6,215,983, 6,208,295, 6,018,317, and in G. J. Pottie and A. R. Calderbank, “Channel Coding Strategies for Cellular Radio”, IEEE Transactions on Vehicular Technology, Vol. 44, No. 4, pp. 763-770, November 1995.

In systems that employ pseudo-random selection algorithms, it may be preferable to cancel most, if not all, of the potentially interfering signals. Other systems may employ identical hopping algorithms, but provide for assigned or randomly selected time offsets. In such cases, the interference canceller 816 may project the received signal onto a signal subspace that is orthogonal to an interference subspace derived from interfering time-offset hopping patterns.

Some systems deliberately offset the timing of frequency hopping intervals between cells assigned to hop over the same subgroup of channels. When the timing offset is a fraction of the hop interval, clashes with different interfering signals occur in only the fraction of the hop interval, thus providing even more interference averaging. Similarly, channels characterized by very long delay spreads may cause ISI. Thus, the interference selector 816 may be configured to adjust the time index in the FFT 813 such that the receiver 810 may integrate each symbol over one or more fractional symbol offsets and identify at least one interference signal therefrom.

FIG. 8B illustrates an embodiment of the FFT 813 in which a plurality K of FFTs 813.0-813.K−1 is provided. An output of one of the FFTs 813.0 is coupled to the tone selector 814. The remaining FFT 813.1-813.K−1 outputs are coupled to the interference selector 816. In one embodiment, the FFTs 813.0-813.K−1 are provided with different time offsets. The time offsets preferably correspond to the K−1 strongest interferers. Alternatively, a single FFT 813 may include a plurality of integrators (not shown) adapted to process transformed digital samples with respect to a plurality of time offsets. Alternative embodiments may employ buffers and/or accumulators in order to provide for a plurality of time-offset FFTs.

In an alternative receiver embodiment, interference resulting from frequency offsets (e.g., Doppler shifts or imposed frequency offsets between cells) may be selected. In particular, the interference selector 816 may select interference values having specific frequency offsets corresponding to strong interferers. Thus, the FFT 813.0 may correspond to a desired signal's subcarrier frequencies, whereas FFTs 813.1-813.K−1 may correspond to fractional frequency offsets of the K−1 strongest interferers. In another embodiment, the FFT 813 may include a single transform having a high enough frequency-domain resolution to enable a plurality of transform components having fractional frequency offsets to be produced. The invention may include alternative specific embodiments adapted to provide for time and/or frequency offsets in a multicarrier receiver.

FIG. 9A illustrates a receiver embodiment of the invention that may be employed in frequency-hopped systems, as well as other types of systems. The receiver includes an RF-to-baseband module 901, a reverse transform 902, a symbol estimator 903, an S-matrix generator, and a projection canceller 906. One or more transmissions are coupled from a communication channel and converted to a digital baseband signal by the RF-to-baseband module 901. The reverse transform 902 operates on the digital baseband signal to produce a plurality of output transform values that are coupled into the symbol estimator 903. For example, each output transform value may correspond to one of a plurality of reverse transform output bins. In some embodiments of the invention, the reverse transform 902 may include the symbol estimator 903. The symbol estimator 903 may include at least one of an equalizer, a matched filter, and a despreader.

Each value in a vector of baseband signal values output by the symbol estimator 902 may be characterized by a linearly independent combination of transmitted data symbols d. At least one of the baseband signal values includes a signal of interest 904.0 that includes interference. The S-matrix generator 905 is configured to process at least one interfering signal, such as interference signals 904.1 to 904.N−1. The S-matrix generator 905 may optionally include an interference selector (not shown) adapted to select a subset of the interference signals 904.1 to 904.N−1 to include in the interference subspace S (i.e., the S-matrix). The projection canceller 906 may include a projection operator configured from the interference subspace S. The signal of interest 904.0 is then projected onto a subspace that is substantially orthogonal to the interference subspace S to produce an estimated data symbol \hat{d}₀.

The S-matrix generator 905 and the projection canceller 906 may be adapted to separate a plurality of signals of interest from interfering signals. For example, one or more signals of interest may be regarded as interfering signals with respect to at least one other signal of interest. Thus, the S-matrix generator 905 may be configured to generate a plurality of interference subspaces corresponding to the different signals of interest. Similarly, the projection canceller 906 may be configured to apply a different projection operator for each signal of interest.

In one aspect of the invention, interference cancellation may be performed as a multi-stage projection wherein a first-stage projection operator may cancel interference that is common to each signal of interest. A set of second-stage projection operators may be configured to process the signal produced by the first stage relative to each signal of interest. In another aspect of the invention, a projection operator configured for a first signal of interest may be reconfigured for other signals of interest. Various computational approaches, such as described in Section IX, may be used to simplify updates to the projection of the projection operator. In one embodiment of the invention, the estimated data symbol \hat{d}₀ may be evaluated in order to update the S-matrix generator 905. The estimated data symbol \hat{d}₀ may then be re-introduced into the projection canceller 906 and operated upon by an updated projection algorithm. Other embodiments of the invention may include alternative approaches to canceling interference in one or more signals of interest.

FIG. 9B illustrates an alternative receiver embodiment of the invention that may be employed in a variety of wireless communication networks. An RF-to-baseband converter 910 produces a digital baseband signal that may be processed by a projection canceller 911. Alternatively, the digital baseband signal may pass through the canceller 911. A reverse transform 912 converts the digital baseband signal into a vector of signal values corresponding to a plurality of transform sub-channel bins. A combiner 913 combines the signal values, which are conveyed to at least one symbol estimator, such as a signal-of-interest estimator 914 and/or an interference estimator 915. The combiner 913 may include at least one of an equalizer, a matched filter, and a despreader. A single symbol estimator may be used in place of the signal-of-interest estimator 914 and the interference estimator 915 to produce a signal-of-interest estimate \hat{d}₀ and at least one interfering-signal estimate \hat{d}₁, . . . , \hat{d}_{N-1}.

Spreading-code information and/or equalization data pertaining to one or more interfering signals may be conveyed from the combiner 913 to an optional spreading code detector 916 and/or an optional spreading/de-equalizer 917. The interfering-signal estimates may be re-spread and/or de-equalized (i.e., returned to a pre-equalization state) in order to approximate their original form prior to combining 913. Summation 918 over each subchannel may optionally be performed in order to reassemble interference components prior to a forward transform 919 operation. A resulting interference estimate may be coupled into the projection canceller 911, which may modify the current version of the digital baseband signal in order to reduce interference in the desired signal \hat{d}₀. The projection canceller 911 may include at least one delay or buffer to time align the interference estimate and the digital baseband signal prior to cancellation.

One embodiment of the invention may be configured as a soft-decision feedback canceller. The interference estimator 915 may be a soft-decision system configured to produce symbol estimates that are weighted by one or more confidence measures. This receiver embodiment may be configured to update the resulting soft-decision estimates upon each iteration until a predetermined condition (e.g., a confidence-measure threshold) is met.

In one aspect of the invention, the signal-of-interest estimator 914 may comprise a soft-decision system. Iterative processing within the receiver may be performed until a predetermined confidence measure or performance measure (e.g., BER) for at least one desired signal is achieved. A condition for continuing iterative processing in the receiver may also include some progress measurement that indicates that further iterative processing is likely to improve the confidence measure and/or a performance measure.

Confidence measures may be implemented via parity checks in the received data. Thus, interference cancellation may be implemented as part of an iterative feedback soft-decision decoding algorithm. In this case, at least one of the interference estimator 915 and the signal-of-interest estimator 914 may comprise a channel decoder (not shown) having appropriate iterative feedback capabilities that include updating the projection canceller 911.

Embodiments of the invention may simply update a projection operator for each iteration, and project the original digital baseband signal with the updated projection operator. Alternatively, a receiver embodiment may store at least one previous projected digital baseband signal and then apply the updated projection operator to the at least one stored signal.

IX. Adaptive Interference Cancellation Operators

Receiver embodiments of the invention may provide for a dynamically adaptable projection operator. For example, adding a new interference contributor to an existing orthogonal projection operator, such as a projection operator P_{S}^{⊥}ₘ generated according to the following form:
P_{S}^{⊥}ₘ=I−Sₘ(Sₘ^{T}Sₘ)⁻¹Sₘ^{T},
expands the interference subspace (i.e., design matrix) Sₘ by one basis function sₘ₊₁, where m is the number of basis functions (i.e., interference vectors) in S.

Adding a new interference contributor has the effect of adding an extra column to the design matrix Sₘ. A resulting new design matrix Sₘ₊₁ can be expressed by:
Sₘ₊₁=|Sₘ sₘ₊₁|
Thus, the term (S^{T}S) can be written as:

$$( {S}_{m + 1}^{T} {S}_{m + 1} ) = \vert \begin{matrix}{S}_{m}^{T} \\ {s}_{m + 1}^{T}\end{matrix} \vert \vert \begin{matrix}{S}_{m} & {s}_{m + 1}\end{matrix} \vert = \vert \begin{matrix}{S}_{m}^{T} {S}_{m} & {S}_{m}^{T} {s}_{m + 1} \\ {s}_{m + 1}^{T} {S}_{m} & {s}_{m + 1}^{T} {s}_{m + 1}\end{matrix} \vert$$

The new projection operator P_{S}^{⊥}ₘ₊₁ is:

$${P}_{S m + 1}^{⊥} = {P}_{S m}^{⊥} - \frac{{P}_{S m}^{⊥} {s}_{m + 1} {s}_{m + 1}^{T} {P}_{S m}^{⊥}}{{s}_{m + 1}^{T} {P}_{S m}^{⊥} {s}_{m + 1}}$$

Similarly, removing a j^{th} basis function sⱼ from Sₘ can be provided in such a way as to simplify the calculation for the new projection operator P_{S}^{⊥}ₘ₋₁:

$${P}_{S m - 1}^{⊥} = {P}_{S m}^{⊥} \frac{{P}_{S m}^{⊥} {s}_{j} {s}_{j}^{T} {P}_{S m}^{⊥}}{{s}_{j}^{T} {P}_{S m}^{⊥} {s}_{j}}$$

Receiver embodiments of the invention may provide for a projection operator to be adaptable to changes in the interference code lengths. For example, an increase in code length corresponds to adding a new row to the design matrix Sₚ, where p is the number of rows (i.e., the spreading-code length):

$${S}_{p + 1} = \vert \begin{matrix}{S}_{p} \\ {s}_{p + 1}^{T}\end{matrix} \vert$$

Thus, the term (Sₚ₊₁^{T},Sₚ₊₁) can be written as:

$$( {S}_{p + 1}^{T} {S}_{p + 1} ) = \vert \begin{matrix}{S}_{p}^{T} & {s}_{p + 1}\end{matrix} \vert \vert \begin{matrix}{S}_{p} \\ {s}_{p + 1}^{T}\end{matrix} \vert = ( {S}_{p}^{T} {S}_{p} ) + {s}_{p + 1} {s}_{p + 1}^{T}$$

The new variance matrix (Sₚ₊₁^{T}Sₚ₊₁)⁻¹ can be expressed by:

$${( {S}_{p + 1}^{T} {S}_{p + 1} )}^{- 1} = {( {S}_{p}^{T} {S}_{p} )}^{- 1} - \frac{{( {S}_{p}^{T} {S}_{p} )}^{- 1} {s}_{p + 1} {{s}_{p + 1}^{T} ( {S}_{p}^{T} {S}_{p} )}^{- 1}}{1 + {{s}_{p + 1}^{T} ( {S}_{p}^{T} {S}_{p} )}^{- 1} {s}_{p + 1}}$$

The new projection operator Pₛ^{⊥}ₚ₊₁ is:

$${P}_{s p + 1}^{⊥} = \vert \begin{matrix}{S}_{p} \\ {s}_{p + 1}^{T}\end{matrix} \vert {( {S}_{p + 1}^{T} {S}_{p + 1} )}^{- 1} \vert \begin{matrix}{S}_{p}^{T} & {s}_{p + 1}\end{matrix} \vert$$

Similarly, a new projection operator P_{S}^{⊥}ₚ₋₁ can be derived from the following expression for the variance matrix (Sₚ₋₁^{T}Sₚ₋₁)⁻¹ when the code length p is decremented relative to sᵢ:

$${( {S}_{p - 1}^{T} {S}_{p - 1} )}^{- 1} = {( {S}_{p}^{T} {S}_{p} )}^{- 1} + \frac{{( {S}_{p}^{T} {S}_{p} )}^{- 1} {s}_{i} {{s}_{i 1}^{T} ( {S}_{p}^{T} {S}_{p} )}^{- 1}}{1 + {{s}_{i 1}^{T} ( {S}_{p}^{T} {S}_{p} )}^{- 1} {s}_{i}}$$

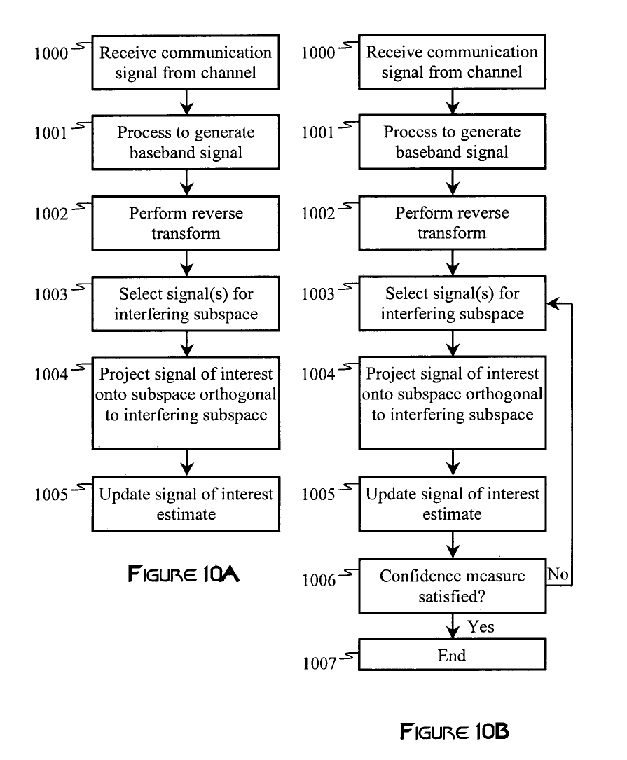

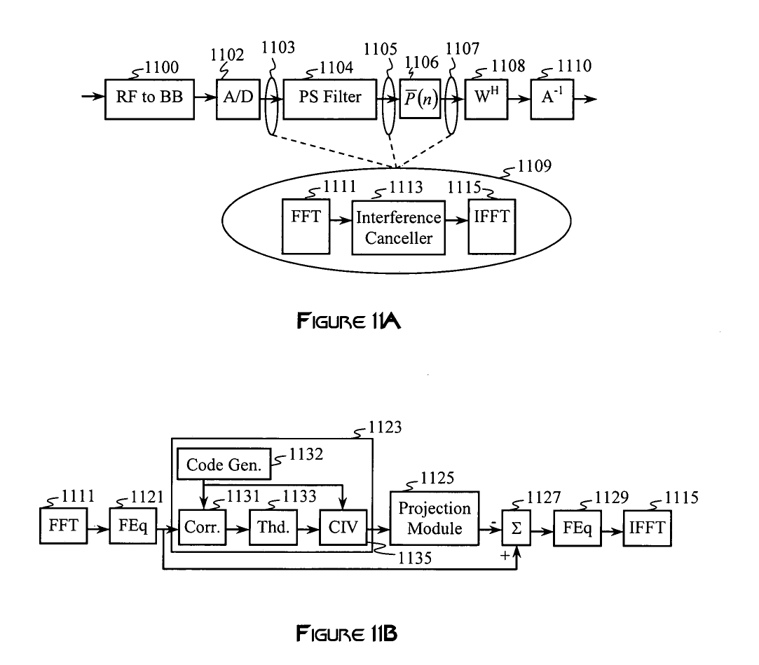

FIG. 10A illustrates a reception method of the invention for canceling selected interfering signals from a signal including at least one signal of interest. A receiver couples received signals from a communication channel 1000 and converts the received signals to at least one baseband signal 1001. A reverse transform is performed 1002 prior to interference selection 1003. At least one signal including at least one signal of interest (which may be selected prior to, or following the reverse transform 1002) is projected onto a subspace that is orthogonal (or approximately orthogonal) to a selected interference subspace 1004. A resulting interference-cancelled signal may be used to update an estimate of the signal of interest 1005.

Embodiments of the invention may provide for iteratively performing the reception method shown in FIG. 10A. For example, FIG. 10B illustrates one such iterative method for updating at least one signal-of-interest estimate 1005. A confidence measure (or some other quality measure) may be evaluated 1006 upon each iteration. If the evaluation 1006 fails, interference selection 1003 may be updated, resulting in an adaptation of the projection operator used in step 1004. An evaluation 1006 failure may optionally reset the at least one signal-of-interest estimate back to a previous value. Some embodiments of the invention may provide confidence measures 1006 for a plurality of signal-of-interest estimates and then select the signal-of-interest estimate(s) corresponding to the most favorable confidence measure(s). Once a predetermined confidence measure or some other predetermined condition (e.g., a predetermined number of iterations) is satisfied 1006, the iterative process ends 1007.

Confidence-measure evaluation 1006 may be provided for the signal of interest and/or at least one interfering signal. Some embodiments may provide for forward error correction decoding (not shown) before the evaluation 1006. For example, a receiver may perform Viterbi decoding followed by Reed-Solomon decoding. Alternatively, parity check coding may be employed. Thus, evaluation 1006 may consider an accumulated error metric from the decoding. Furthermore, soft-decision or hard-decision estimates of the interfering signals may then be fed back to the interference-selection step 1003.

X. Interference Cancellation for CDMA

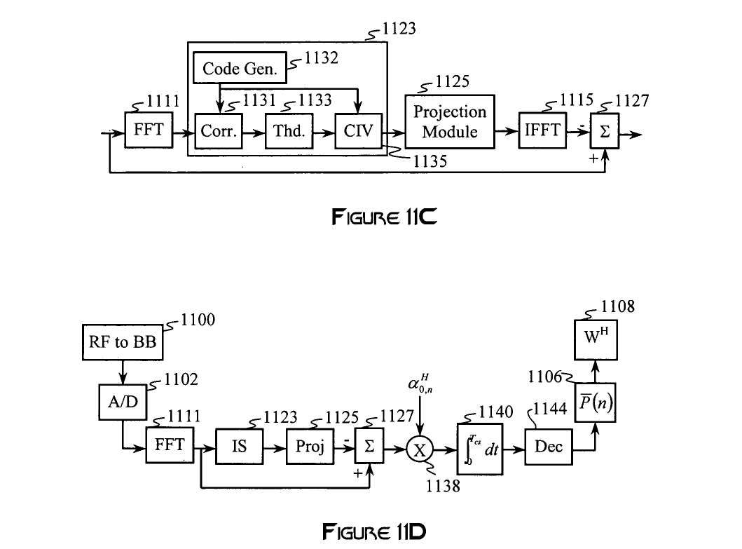

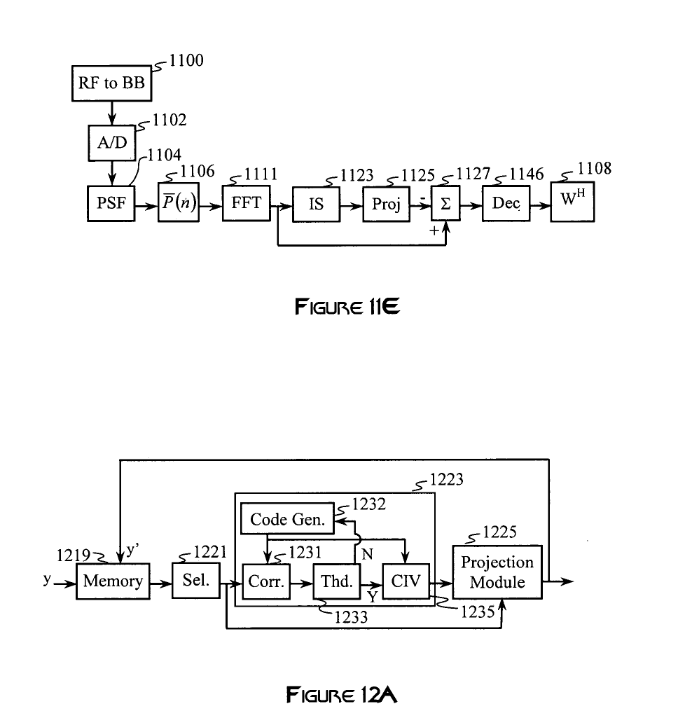

FIG. 11A illustrates a CDMA receiver embodiment of the invention that is configured to perform frequency-domain interference cancellation. An RF-to-baseband module 1100 is coupled to an A/D converter 1102, which is followed by a pulse-shaping filter 1104, a despreader 1106, and a Walsh decoder 1108. An optional scaling adjuster 1110 may be included. A frequency-domain interference-cancellation system 1109 (which comprises an FFT 1111, a projection-based interference canceller 1113, and an IFFT 1115) may be included at one or more positions 1103, 1105, and 1107 in the receiver.

In a CDMA system (such as a CDMA2000 or WCDMA system), a transmitter may scale one or more data sequences for transmission based on transmission signal powers that are necessary to serve recipients of the corresponding data sequences. Each data bit is spread with an orthogonalizing code, such as a Walsh covering code or an “orthogonal variable spread factor” (OVSF) code. An OVSF code is essentially a Walsh code having different code indices. The resulting spread data is then spread with a transmitter-specific scrambling code, or PN sequence. In WCDMA, Gold codes are typically used for scrambling. The scrambled signals are then over-sampled and processed in a transmit filter, such as a pulse-shaping filter, prior to being up-converted and transmitted into a communication channel.

A CDMA receiver, such as the CDMA receiver shown in FIG. 11A, processes received signals in the RF-to-baseband module 1100 to produce a baseband analog signal. The A/D converter 1102 produces a digital baseband signal output that may be processed by the interference-cancellation system 1109 in order to remove interference prior to processing by the pulse-shaping filter 1104. In WCDMA systems, a square raised cosine filter is typically used as a pulse-shaping filter on both the transmit side and the receive side of a communication link. In an alternative embodiment, an interpolating filter (not shown) may be used. An interpolating filter may be configured to approximate the combined effects of transmit and receive pulse-shaping filters. In an exemplary embodiment, a linear interpolator may be used. Another exemplary embodiment may employ a raised-cosine interpolating filter having a predetermined roll-off factor.

The pulse-shaping filter 1104 produces an output that may be processed by the despreader 1106, which applies the complex conjugate of the scrambling code(s) or PN sequence(s) used by the transmitter to spread the received signal prior to transmission. In a WCDMA system, the despreader 1106 may be configured to employ Gold code despreading. The pulse-shaping filter 1104 output may optionally be coupled into a frequency-domain interference-cancellation system, such as the interference-cancellation system 1109, in order to cancel interference prior to despreading 1106. Similarly, a despread signal output by the despreader 1106 may be processed for interference cancellation, such as by the interference-cancellation system 1109, before being processed by the Walsh decoder 1108. It is common for the Walsh decoder 1108 to implement a fast Walsh transform or an equivalent type (e.g., OVSF) of fast transform.

FIG. 11B illustrates an exemplary embodiment of a frequency-domain interference-cancellation system, such as the interference-cancellation system 1109. An input digital baseband signal is decomposed into a plurality N of frequency-domain subchannels by the FFT 1111. In one embodiment of the invention, the interference-cancellation system 1109 is located at position 1103, and the FFT 1111 produces an N-element frequency-domain vector y(f)={y(f₀), . . . , y(f_{N-1})} corresponding to at least one scrambling-code chip duration T_{cs}. In another embodiment of the invention, the interference-cancellation system 1109 is located at position 1105, and the FFT 1111 produces an N-element frequency-domain vector y(f) corresponding to at least one orthogonalizing-code chip duration T_{co}. In this case, the number N may correspond to the number of scrambling-code chips occurring within a time interval of one orthogonalizing-code chip. Alternatively, the block length of the FFT 1111 may span a data-symbol duration of Tₛ, and the number N may be the number of scrambling-code chips within each data symbol. In yet another embodiment of the invention, the interference-cancellation system 1109 may be positioned at 1107 and the FFT 1111 configured to produce an N-element vector output y(f) corresponding to at least one data-symbol duration Tₛ. In this case, the number N may be the number of orthogonalizing-code chips occurring within the data symbol interval Tₛ.

A particular frequency-domain vector value y(fₙ) may be expressed by:

$$y ( {f}_{n} ) = {α}_{n} {β}_{n} {\sum }_{m = 0}^{M - 1} {A}_{m} {c}_{m} ( {f}_{n} ) {d}_{m}$$

where αₙ is a complex channel fade corresponding to frequency fₙ, βₙ is a frequency-domain pulse-shaping factor, Aₘ represents any amplitude scaling that may have been provided to an m^{th} user's transmission, dₘ represents the m^{th} user's transmitted data symbol, cₘ(fₙ) is a frequency-domain equivalent of any time-domain spreading code (e.g., a scrambling code and/or an orthogonalizing code) that may have been used to spread the corresponding data symbol dₘ, and M−1 is the number of potentially interfering channels with respect to a signal-of-interest, which is assigned to an arbitrary index value m=0. Thus, a frequency-domain vector y(f) may represent a linear combination of vector components yₘ(f) {m=0, . . . M−1}.

Various communication-system parameters and receiver configurations will dictate the actual form of the frequency-domain vector y(f). For example, the term Aₘ may be present in y(f) for a CDMA2000 system, but absent in a WCDMA system. The terms βₙ depend on whether the interference-cancellation system 1109 is located before or after the pulse-shaping filter 1104. If the interference-cancellation system 1109 is located at 1107, the term cₘ(fₙ) is the frequency-domain equivalent of the orthogonalizing code (e.g., a Walsh code in CDMA2000 or an OVSF code in WCDMA). If the interference-cancellation system 1109 is located at positions 1103 or 1105, the term cₘ(fₙ) is a frequency-domain representation of the orthogonalizing code spread by the scrambling code. An optional frequency-domain equalizer 1121 may be provided to equalize the values of αₙ.

An interference selector 1123 is configured to identify frequency-domain code spaces that may contribute a predetermined amount of interference to the signal of interest. In an exemplary embodiment, the interference selector 1123 comprises a correlator 1131, a code generator 1132, a threshold detector 1133, and a CIV (combined interference vector) generator 1135. The code generator 1132 produces code sequences that may correspond to interfering code spaces. Correlations between the code sequences and the frequency-domain vector y(f) produce values that are compared with at least one threshold value in the threshold detector 1133. A value that exceeds the threshold is presumed to represent a code space that contributes a significant portion of interference to the signal of interest. The threshold detector 1133 may derive the at least one threshold value from one or more channels known to be present (e.g., common channels). Alternatively, the threshold detector 1133 may employ averaging or some other mathematical function across a plurality of code channels to derive the threshold. Codes that produce values exceeding the at least one threshold are then used by the CIV generator 1135 to construct a CIV. The CIV may comprise an interference matrix (e.g., an S matrix of rank greater than one), a linear combination of interference vectors (e.g., an S matrix of rank one), or an S matrix comprising one or more vectors representing a linear combination of interference vectors.

In some embodiments of the invention, the interference selector 1123 may employ a channel emulator (not shown) configured to impart a predetermined channel response to the generated codes and/or the CIV. For example, the code generator 1132 may include a channel emulator (not shown) to produce one or more code sequences exhibiting similar distortions as the channel distortions αₙ in the frequency-domain vector y(f). If the receiver embodiments shown in FIGS. 11A and 11B are configured to operate in a cellular handset, different component vectors in the frequency-domain vector y(f) in a received downlink signal may have substantially identical channel distortions αₙ. However, in a cellular base station, the frequency-domain vector y(f) in a received uplink signal may have vector components yₘ(f) characterized by different channel distortions αₙ. Thus, the equation for y(fₙ) may be expressed as follows:

$$y ( {f}_{n} ) = {β}_{n} {\sum }_{m = 0}^{M - 1} {α}_{mn} {A}_{m} {c}_{m} ( {f}_{n} ) {d}_{m}$$

where αₘₙ is a complex channel fade corresponding to both user index m and frequency fₙ. Accordingly, embodiments of the invention may be configured to emulate and/or compensate for either or both user-specific and frequency-specific channel distortions. In an alternative embodiment of the invention, the CIV generator 1135 may include a channel emulator (not shown) configured to distort the CIV.

The CIV output from the interference selector 1123 is processed in a projection module 1125. The projection module 1125 and a combiner 1127 are configured to project the frequency-domain vector y(f) onto a subspace that is orthogonal to interference represented by the CIV. In one embodiment of the invention, the projection module 1125 may produce a projection output vector of
P_{S}=S(S^{H}S)⁻¹S^{H}y,
and the combiner 1127 may subtract P_{S} from the frequency-domain vector y. In some embodiments, the projection module 1125 may include the combiner 1127 to produce a projection operation defined by:
P_{S}^{⊥}=y−S(S^{H}S)⁻¹S^{H}y
Optional frequency-domain equalization 1129 may be provided prior to the IFFT 1115.

FIG. 11C shows an alternative embodiment of an interference-cancellation system that is configured to operate on an input time-domain vector y. The interference selector 1123 and the projection module 1125 process a frequency-domain version of y. Accordingly, channel emulators (not shown) at either the code generator 1132 or the CIV generator 1135 may be configured to provide a frequency-domain channel distortion to the generated codes or the CIV, respectively. Furthermore, various embodiments may provide for equalization of the time-domain vector y, the frequency-domain vector y, and/or the CIV. The IFFT 1115 converts the projection output vector P_{S} from the time-domain vector y.

Various embodiments of the invention may exploit spectral variations between at least one signal of interest and at least one interfering signal in order to project out the at least one interfering signal from the signal of interest. Spectral variations due to propagation differences may be processed across each individual scrambling-code chip. A plurality of scrambling-code chips corresponding to each individual orthogonalizing code chip may be processed to exploit spectral variations resulting from different scrambling codes, as well as propagation differences in received overlapping signals. Similarly, spectral processing across individual data symbols may be facilitated by spectral differences arising from different orthogonalizing codes, different scrambling codes, and/or different propagation paths of a plurality of received overlapping signals.

FIG. 11D shows an exemplary embodiment of an interference-cancellation system configured to perform frequency-domain interference cancellation on a received signal. An A/D converter 1102 produces a digital baseband signal output characterized by N samples per scrambling-code chip duration T_{cs}. An N-point FFT 1111 processes samples from A/D converter 1102 to produce up to an N-element frequency-domain vector y(f) corresponding to at least one scrambling-code chip duration T_{cs}.

Each element of vector y(f) corresponds to a spectral component of the received signal. A signal of interest that experiences different propagation conditions relative to one or more interfering signals is likely to be characterized by different spectral-component fades, such as represented by the spectral components (i.e., elements) in y(f). Thus, a set of spectral components yₘ(f) corresponding to an m^{th} user (e.g., the signal of interest or each of the one or more interfering signals) represents an m^{th} frequency-domain code space. Furthermore, different propagation conditions can also result in different path delays, and hence, different inter-chip interference profiles in the received signal. Differences in scrambling codes and/or orthogonalizing codes can also result in spectral differences between users.

An interference selector 1123 is configured to identify frequency-domain code spaces that may contribute a predetermined amount of interference to the signal of interest. A code generator 1132 may generate a predetermined number of frequency-domain codes corresponding to interference channels that are known and/or likely to be present. The code generator 1132 may be configured to generate frequency-domain codes relative to any combination of user-specific signaling parameters, including different complex channel fades αₘₙ, user-specific frequency-domain pulse-shaping factors βₘₙ, and/or frequency-domain equivalents of any time-domain spreading codes cₘ(fₙ). In some embodiments, the code generator 1132 may determine which codes to generate based on a cross correlation between the code space of a signal of interest and potentially interfering codes. For example, it may be advantageous to avoid canceling highly correlated interference from the signal of interest. Similarly, a determination of which codes to include in the CIV may be made by a threshold detector 1133.

In one embodiment of the invention, the threshold detector 1133 may compare a correlation between one or more code sequences and the frequency-domain vector y(f) to produce one or more values for comparison with at least one threshold value. A threshold value may be determined from an interfering channel (e.g., a pilot channel, a control information channel, a signaling channel, a link maintenance channel, a broadcast channel, or a user channel) known to be present. Alternatively, a threshold value may be determined from an average (or some other function) of a plurality of channels. For example, all possible channels or a plurality of channels known to be active may be used. In another aspect of the invention, each code sequence may be selected if the power of the combined signal produced by combiner 1127 exceeds a predetermined threshold, such as (but not limited to) the power of the frequency-domain signal y(f) produced by the FFT 1111. In yet another embodiment of the invention, the interference selector 1123 may be part of an iterative feedback loop (not shown) in which threshold detection is performed for only one code at a time for each pass through the loop.

A projection module 1125 and a combiner 1127 are configured to project the frequency-domain vector y(f) onto a subspace that is orthogonal to an interference subspace represented by the CIV. The combiner 1127 produces an interference-canceled digital sequence by summing frequency-domain components of the projected vector y(f) for each sample increment T_{cs}/N. Optional frequency-domain equalization 1138 may be performed prior to integrating 1140 the interference-canceled sequence over each of a plurality of scrambling-code chip durations T_{cs}. An optional pulse-shaping filter (not shown) may be included at any of various places throughout a receiver, such as preceding the FFT 1111, in the interference selector 1123, inside the combiner 1127, within the frequency-domain equalizer 1138, and/or prior to integrator 1140. A decision module 1144 produces a vector of decision variables wherein each variable corresponds to a scrambling-code chip interval T_{cs}. In some embodiments, the decision module 1144 may also function as an equalizer. A descrambler 1106 descrambles the vector of decision variables and is followed by a despreader (e.g., a Walsh decoder) 1108. Further baseband signal-processing modules (not shown) typically follow the despreader 1108.

FIG. 11E illustrates an alternative interference-cancellation receiver wherein interference cancellation is performed following a descrambler 1106. An FFT 1111 is configured to produce a plurality N of spectral components (represented by frequency-domain vector y(f)) from an input descrambled signal. In an exemplary embodiment of the invention, the plurality N of spectral components equals the number of orthogonalizing-code chips in a data-symbol interval T_{S}. Thus, each spectral component may be regarded as a frequency-domain sample for a particular time interval, such as the data-symbol interval T_{S}.

An interference selector 1123 is configured to identify frequency-domain code spaces that may contribute at least a predetermined amount of interference to at least one signal of interest. A code generator (not shown) in the interference selector 1123 may produce frequency-domain code sequences corresponding to time-domain orthogonalizing-code spaces that interfere with the code space of the at least one signal of interest. A projection module 1125 and a combiner 1127 are configured to project the frequency-domain vector y(f) onto a subspace that is orthogonal to interference represented by a frequency-domain CIV. In one embodiment of the invention, the combiner 1127 may be configured to produce a frequency-domain interference-cancelled vector. An optional decision module 1146 may provide a data-symbol estimate for values output by the combiner 1127. The decision module 1146 may optionally be placed following the despreader 1108. The despreader 1108 may be configured to provide a frequency-domain version of at least one orthogonalizing decoding vector to an interference-cancelled vector.

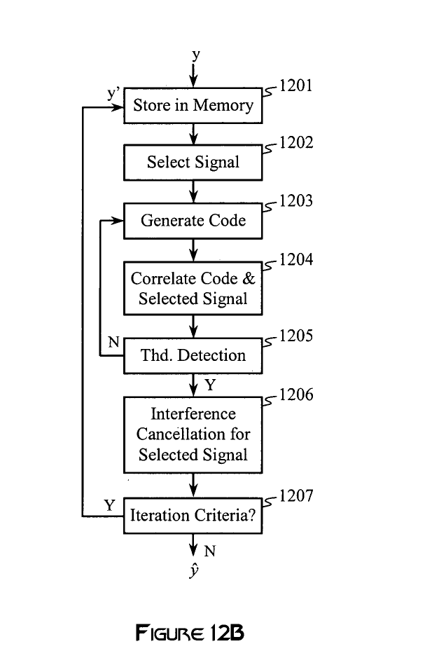

FIG. 12A is a block diagram of an apparatus and method embodiment of the invention configured for performing iterative feedback interference cancellation. A cancellation system implemented in a receiver includes a memory 1219, a signal-selection module 1221, an interference selector 1223, and a projection module 1225. The interference selector 1223 includes a code generator 1232, a correlator 1231, a threshold detector 1233, and a CIV generator 1235. The threshold detector 1233 is provided with a control means coupled to the code generator 1232, and the projection module 1225 is configured to feed back an output signal to the memory 1219.

FIG. 12B is a flow chart representing an iterative feedback interference cancellation embodiment of the invention. An input digital baseband signal y may be stored in memory 1201 (such as memory 1219) and then passed through signal-selection module 1221. Signal selection 1202 is typically performed when two or more signals are stored in the memory 1201. For example, signal selection 1202 may provide for selecting a signal based on at least one signal-measurement criterion, such as determining which signal has the greatest power. However, in the first iteration, there may be no second signal y′. Thus, signal selection 1202 may comprise a simple pass-through operation to the interference selector 1223. In either case, the signal coupled into the interference selector 1223 is referred to as a selected signal.

A code-generation step 1203 produces at least one code, which may be correlated 1204 with the selected signal to produce a correlation value. The code corresponds to at least one code space that may be occupied by an interfering signal, thus identifying the at least one code space as potential interference to the selected signal. The correlation value typically indicates the degree of interference in the selected signal due to the at least one interfering code space. Threshold detection 1205 may determine whether the interfering code space contributes at least a predetermined amount of interference to the selected signal. That is, a determination is made as to whether or not there is significant signal power in the interfering code space. If a predetermined threshold-detection condition is not met, the code-generation step 1203 provides at least one alternative code, and the correlation 1204 and the threshold detection 1205 are repeated. Otherwise, the code and the selected signal are processed for interference cancellation 1206.

In one embodiment of the invention, the CIV generator 1235 and the projection module 1225 are configured to perform interference cancellation 1206. For example, the CIV generator 1235 may use one or more codes to produce a CIV. The projection module 1225 and a combiner (not shown) may be configured to project the selected signal onto a subspace that is orthogonal to interference represented by the CIV.

The projection module 1225 may make an iteration determination 1207 whether or not to perform a subsequent iteration. For example, the determination 1207 may be based on whether there are any codes left for processing. Alternatively, other criteria may be used, such as the number of iterations performed, any confidence or performance measure related to the accuracy of demodulated data, the number of active code spaces, and/or some comparison of at least one interference-cancelled signal y′ with the original input signal y or a previous interference-cancelled signal. If there is a decision to perform another iteration, the interference-cancelled signal y′ is stored in memory 1201 along with the input digital baseband signal y, and/or a previous interference-cancelled signal. Signal selection 1202 selects one of the signals based on the at least one signal-measurement criterion, and the steps 1203-1207 are repeated. If the iteration determination 1207 results in a decision not to perform another iteration, the interference-cancelled signal may be provided as an output signal ŷ, or the signal selection 1202 may be used to select between either the interference-cancelled signal or a previous signal stored in the memory 1219.

All publications and patent applications mentioned in this specification are herein incorporated by reference to the same extent as if each individual publication or patent application was specifically and individually incorporated by reference.

Various embodiments of the invention may include variations in system configurations and the order of steps in which methods are provided. In many cases, multiple steps and/or multiple components may be consolidated.

The method and system embodiments described herein merely illustrate particular embodiments of the invention. It should be appreciated that those skilled in the art will be able to devise various arrangements, which, although not explicitly described or shown herein, embody the principles of the invention and are included within its spirit and scope. Furthermore, all examples and conditional language recited herein are intended to be only for pedagogical purposes to aid the reader in understanding the principles of the invention. This disclosure and its associated references are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated by those skilled in the art that the block diagrams herein represent conceptual views of illustrative circuitry, algorithms, and functional steps embodying principles of the invention. Similarly, it should be appreciated that any flow charts, flow diagrams, signal diagrams, system diagrams, codes, and the like represent various processes which may be substantially represented in computer-readable medium and so executed by a computer or processor, whether or not such computer or processor is explicitly shown.

The functions of the various elements shown in the drawings, including functional blocks labeled as “processors” or “systems,” may be provided through the use of dedicated hardware as well as hardware capable of executing software in association with appropriate software. When provided by a processor, the functions may be provided by a single dedicated processor, by a shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, the function of any component or device described herein may be carried out through the operation of program logic, through dedicated logic, through the interaction of program control and dedicated logic, or even manually, the particular technique being selectable by the implementer as more specifically understood from the context.

Any element expressed herein as a means for performing a specified function is intended to encompass any way of performing that function including, for example, a combination of circuit elements which performs that function or software in any form, including, therefore, firmware, micro-code or the like, combined with appropriate circuitry for executing that software to perform the function. Embodiments of the invention as described herein reside in the fact that the functionalities provided by the various recited means are combined and brought together in the manner which the operational descriptions call for. Applicant regards any means which can provide those functionalities as equivalent as those shown herein.

1. An apparatus adapted to receive a plurality of transmitted signals, comprising:
a. a reverse transform configured to produce a vector of baseband signal values, and
b. a projection canceller coupled to said reverse transform, said projection canceller configured to project the vector of baseband signal values onto at least one subspace that is substantially orthogonal to an interference subspace.

2. The apparatus recited in claim 1 further comprising an interference selector coupled to said projection canceller, said interference selector configured to select at least one interference component to include in the interference subspace.

3. The apparatus recited in claim 2 wherein said interference selector is configured to employ at least one of an analytically determined interference distribution and a measured interference distribution when selecting the at least one interference component.

4. The apparatus recited in claim 2 wherein said interference selector is configured to select the at least one interference component based on at least one of known channel measurements and known spreading codes.

5. The apparatus recited in claim 2 wherein said interference selector is configured to select the at least one interference component to optimize at least one signal-quality parameter of at least one received signal.

6. The apparatus recited in claim 5 wherein said interference selector is configured to select the at least one interference component as part of an iterative process for optimizing the at least one signal-quality parameter of the at least one received signal.

7. The apparatus recited in claim 2 wherein said interference selector is configured to select the at least one interference component to optimize at least one complexity/performance trade-off.

8. The apparatus recited in claim 2 wherein said interference selector is configured to select the at least one interference component relative to its correlation with at least one desired signal.

9. The apparatus recited in claim 2 wherein said interference selector is configured to select the at least one interference component with respect to at least one predetermined delay threshold.

10. The apparatus recited in claim 1 wherein the reverse transform includes at least one of a Fourier transform, a wavelet transform, a Walsh transform, and a Hankel transform.

11. The apparatus recited in claim 1 wherein the reverse transform includes at least one of a block transform, a sliding transform, a passband filter bank, and a quadrature-mirror filter bank.

12. The apparatus recited in claim 1 wherein the reverse transform includes an antenna array.

13. The apparatus recited in claim 12 wherein the antenna array includes at least one of a set of antennas including a plurality of spatially separated antennas and a plurality of differently polarized antennas.

14. The apparatus recited in claim 12 wherein the antenna array includes at least one of a plurality of filter banks and a plurality of Rake receivers.

15. The apparatus recited in claim 1 wherein the reverse transform includes at least one of an equalizer and a matched filter.

16. The apparatus recited in claim 1 wherein the reverse transform comprises a despreading operator.

17. The apparatus recited in claim 16 wherein the despreading operator is adapted to decode at least one of a set of spreading codes, including Hadamard-Walsh codes, complex codes derived from DFT coefficients, Frank-Zadoff codes, and Chu sequences.

18. The apparatus recited in claim 1 wherein the reverse transform comprises a square-matrix operator.

19. The apparatus recited in claim 1 wherein the reverse transform is adapted to recover transmitted data symbols mapped onto at least one signal subspace, including a code subspace, a frequency subspace, a path-diversity subspace, a wavelet subspace, and a polarization subspace.

20. The apparatus recited in claim 1 wherein the reverse transform comprises a synthesis operator represented by a polyphase matrix.

21. The apparatus recited in claim 1 wherein the reverse transform comprises a plurality of orthogonal basis functions.

22. The apparatus recited in claim 1 wherein at least one of the reverse transform and the projection canceller is adaptable to changing channel conditions.

23. The apparatus recited in claim 1 wherein the reverse transform and the projection canceller are implemented via an enhanced reverse-transform operator.

24. The apparatus recited in claim 1 wherein the projection canceller is configured to produce at least one projection operator having a form expressed by at least one of Pₛ^{⊥}=I−S(S^{T}S)⁻¹S^{T} and Pₛ^{⊥}=I−S(S^{H}S)⁻¹S^{H}, where Pₛ^{⊥} is a projection operator, I is an identity matrix, S is an interference matrix, S^{T} is a transpose of the interference matrix, and S^{H} is a conjugate transpose of the interference matrix.

25. The apparatus recited in claim 24 wherein the projection operator includes one or more regularisation parameters.

26. The apparatus recited in claim 24 wherein the projection operator is configured to optimize at least one received signal parameter.

27. The apparatus recited in claim 24 wherein the projection operator is adaptable to at least one of changes in the number of basis functions and changes in the basis function length.

28. The apparatus recited in claim 24 wherein the projection operator is configured to orthogonalize a plurality of column vectors in the interference matrix S.

29. The apparatus recited in claim 24 wherein the projection operator is configured to generate the interference matrix S from a linear combination of interference vector subspaces.

30. The apparatus recited in claim 1 wherein the plurality of transmitted signals includes at least one of a set of signals, including cdmaOne, cdma2000, 1xRTT, cdma 1xEV-DO, cdma 1xEV-DV, cdma2000 3x, WCDMA, Broadband CDMA, UMTS, GPS, OFDM, MC-CDMA, Spread-OFDM, HSDPA, and frequency-hopped signals.

31. A handset adapted to receive a plurality of transmitted signals, comprising:
a. a reverse transform configured to produce a vector of baseband signal values, and
b. a projection canceller coupled to said reverse transform, said projection canceller configured to project the vector of baseband signal values onto at least one subspace that is substantially orthogonal to an interference subspace.

32. The handset recited in claim 31 further comprising an interference selector coupled to said projection canceller, said interference selector configured to select at least one interference component to include in the interference subspace.

33. The handset recited in claim 32 wherein said interference selector is configured to employ at least one of an analytically determined interference distribution and a measured interference distribution when selecting the at least one interference component.

34. The handset recited in claim 32 wherein said interference selector is configured to select the at least one interference component based on at least one of known channel measurements and known spreading codes.

35. The handset recited in claim 32 wherein said interference selector is configured to select the at least one interference component to optimize at least one signal-quality parameter of at least one received signal.

36. The handset recited in claim 35 wherein said interference selector is configured to select the at least one interference component as part of an iterative process for optimizing the at least one signal-quality parameter of the at least one received signal.

37. The handset recited in claim 32 wherein said interference selector is configured to select the at least one interference component to optimize at least one complexity/performance trade-off.

38. The handset recited in claim 32 wherein said interference selector is configured to select the at least one interference component relative to its correlation with at least one desired signal.

39. The handset recited in claim 32 wherein said interference selector is configured to select the at least one interference component with respect to at least one predetermined delay threshold.

40. The handset recited in claim 31 wherein the reverse transform includes at least one of a Fourier transform, a wavelet transform, a Walsh transform, and a Hankel transform.

41. The handset recited in claim 31 wherein the reverse transform includes at least one of a block transform, a sliding transform, a passband filter bank, and a quadrature-mirror filter bank.

42. The handset recited in claim 31 wherein the reverse transform includes an antenna array.

43. The handset recited in claim 42 wherein the antenna array includes at least one of a set of antennas including a plurality of spatially separated antennas and a plurality of differently polarized antennas.

44. The handset recited in claim 42 wherein the antenna array includes at least one of a plurality of filter banks and a plurality of Rake receivers.

45. The handset recited in claim 31 wherein the reverse transform includes at least one of an equalizer and a matched filter.

46. The handset recited in claim 31 wherein the reverse transform comprises a despreading operator.

47. The handset recited in claim 46 wherein the despreading operator is adapted to decode at least one of a set of spreading codes, including Hadamard-Walsh codes, complex codes derived from DFT coefficients, Frank-Zadoff codes, and Chu sequences.

48. The handset recited in claim 31 wherein the reverse transform comprises a square-matrix operator.

49. The handset recited in claim 31 wherein the reverse transform is adapted to recover transmitted data symbols mapped onto at least one signal subspace, including a code subspace, a frequency subspace, a path-diversity subspace, a wavelet subspace, and a polarization subspace.

50. The handset recited in claim 31 wherein the reverse transform comprises a synthesis operator represented by a polyphase matrix.

51. The handset recited in claim 31 wherein the reverse transform comprises a plurality of orthogonal basis functions.

52. The handset recited in claim 31 wherein at least one of the reverse transform and the projection canceller is adaptable to changing channel conditions.

53. The handset recited in claim 31 wherein the reverse transform and the projection canceller are implemented via an enhanced reverse-transform operator.

54. The handset recited in claim 31 wherein the projection canceller is configured to produce at least one projection operator having a form expressed by at least one of Pₛ^{⊥}=I−S(S^{T}S)⁻¹S^{T} and Pₛ^{⊥}=I−S(S^{H}S)⁻¹S^{H}, where Pₛ^{⊥} is a projection operator, I is an identity matrix, S is an interference matrix, S^{T} is a transpose of the interference matrix, and S^{H} is a conjugate transpose of the interference matrix.

55. The handset recited in claim 54 wherein the projection operator includes one or more regularisation parameters.

56. The handset recited in claim 54 wherein the projection operator is configured to optimize at least one received signal parameter.

57. The handset recited in claim 54 wherein the projection operator is adaptable to at least one of changes in the number of basis functions and changes in the basis function length.

58. The handset recited in claim 54 wherein the projection operator is configured to orthogonalize a plurality of column vectors in the interference matrix S.

59. The handset recited in claim 54 wherein the projection operator is configured to generate the interference matrix S from a linear combination of interference vector subspaces.

60. The handset recited in claim 31 wherein the plurality of transmitted signals includes at least one of a set of signals, including cdmaOne, cdma2000, 1xRTT, cdma 1xEV-DO, cdma 1xEV-DV, cdma2000 3x, WCDMA, Broadband CDMA, UMTS, GPS, OFDM, MC-CDMA, Spread-OFDM, HSDPA, and frequency-hopped signals.

61. A communication system comprising:
a. a transmitter configured to couple at least one transmit signal into a communication channel, and
b. a receiver configured to couple the at least one transmit signal from the communication channel to produce at least one received signal, the receiver comprising:
i. a reverse transform configured to process the at least one received signal to produce a vector of baseband signal values, and
ii. a projection canceller coupled to said reverse transform, said projection canceller configured to project the vector of baseband signal values onto at least one subspace that is substantially orthogonal to an interference subspace.

62. The communication system recited in claim 61 wherein the transmitter is configured to map a plurality of data symbols onto at least one signal subspace.

63. The communication system recited in claim 61 wherein the transmitter includes a forward transform.

64. The communication system recited in claim 63 wherein the forward transform is configured to employ precoding.

65. The communication system recited in claim 63 wherein the forward transform is configured to employ at least one set of spreading codes, including orthogonal and non-orthogonal spreading codes.

66. The communication system recited in claim 63 wherein the forward transform is configured to employ spreading.

67. The communication system recited in claim 63 wherein the forward transform is configured to structure interference in the at least one received signal.

68. The communication system recited in claim 63 wherein the forward transform is further configured to employ diversity to decorrelate highly correlated signal spaces.

69. The communication system recited in claim 63 wherein the forward transform and the reverse transform are configured to employ biorthogonal bases.

70. The communication system recited in claim 63 wherein the forward transform is operable in a first signal space and the reverse transform is operable in a second signal space wherein the second signal space is different from the first signal space.

71. The communication system recited in claim 63 wherein the forward transform is adapted to produce a multicarrier signal, wherein the at least one transmit signal comprises the multicarrier signal.

72. The communication system recited in claim 71 wherein the forward transform is configured to provide the multicarrier signal with at least one of frequency interleaving and frequency hopping.

73. The communication system recited in claim 71 wherein the forward transform is configured to provide the multicarrier signal with at least one spreading code.

74. The communication system recited in claim 73 wherein the forward transform is configured to provide the at least one spreading code with at least one of a set of complex weights, including pulse-shaping coefficients, spectral-smoothing functions, and PAPR-reduction codes.

75. The communication system recited in claim 63 wherein the at least one transmit signal comprises a plurality of transmit signals and the forward transform is configured to provide each of a plurality of transmit signals with linearly independent spreading gains.

76. The communication system recited in claim 63 wherein the at least one transmit signal comprises a plurality of transmit signals and the forward transform is configured to condition the communication channel to impart linearly independent channel distortions to the plurality of transmit signals.

77. The communication system recited in claim 61 wherein the transmitter further comprises an interference-structuring module configured to distribute interference across at least one signal subspace in a predetermined manner.

78. The communication system recited in claim 77 wherein the interference-structuring module is configured to perform at least one of spreading-code selection, precoding, frequency interleaving, array processing, and polarization division multiplexing.

79. The communication system recited in claim 77 further comprising a communicative coupling between the interference-structuring module and the projection canceller.

80. A method for processing a composite signal comprising at least one signal of interest, the method comprising the steps of:
(a) providing for performing a reverse transform on the composite signal to produce a plurality of baseband signal portions; and
(b) providing for projecting a signal space corresponding to the plurality of baseband signal portions onto a signal space substantially orthogonal to an interference signal space for canceling interference from the at least one signal of interest.

81. The method recited in claim 80 wherein providing for projecting a signal space comprises providing for interference selection for selecting at least one interference component to include in the interference signal space.

82. The method recited in claim 81 wherein providing for interference selection includes employing at least one of an analytically determined interference distribution and a measured interference distribution for selecting the at least one interference component.

83. The method recited in claim 81 wherein providing for interference selection includes selecting the at least one interference component based on at least one of known channel measurements and known transmit spreading codes.

84. The method recited in claim 81 wherein providing for interference selection includes selecting the at least one interference component to improve at least one signal-quality parameter of at least one received signal.

85. The method recited in claim 84 wherein providing for interference selection is part of an iterative process to improve the at least one signal-quality parameter of at least one received signal.

86. The method recited in claim 81 wherein providing for interference selection includes selecting the at least one interference component to provide at least one predetermined complexity/performance trade-off.

87. The method recited in claim 81 wherein providing for interference selection includes selecting the at least one interference component relative to its correlation with the at least one signal of interest.

88. The method recited in claim 81 wherein providing for interference selection includes selecting the at least one interference component relative to at least one predetermined delay threshold.

89. The method recited in claim 80 wherein providing for performing the reverse transform includes performing at least one of a Fourier transform, a wavelet transform, a Walsh transform, and a Hankel transform.

90. The method recited in claim 80 wherein providing for performing the reverse transform includes performing at least one of a block transform, a sliding transform, a passband filtering operation, and a quadrature-mirror filtering operation.

91. The method recited in claim 80 wherein providing for performing the reverse transform includes receiving the composite signal with an antenna array.

92. The method recited in claim 92 wherein the antenna array includes at least one of a set of antennas including a plurality of spatially separated antennas and a plurality of differently polarized antennas.

93. The method recited in claim 93 wherein the antenna array further includes at least one of a plurality of filter banks and a plurality of Rake receivers.

94. The method recited in claim 80 wherein providing for performing the reverse transform includes at least one of equalizing and matched filtering the composite signal.

95. The method recited in claim 80 wherein providing for performing the reverse transform comprises providing for applying a despreading operator.

96. The method recited in claim 95 wherein providing for applying the despreading operator includes decoding at least one of a set of spreading codes, including Hadamard-Walsh codes, complex codes derived from DFT coefficients, Frank-Zadoff codes, and Chu sequences.

97. The method recited in claim 80 wherein providing for performing the reverse transform comprises providing for applying a square-matrix operator.

98. The method recited in claim 80 wherein providing for performing the reverse transform includes recovering transmitted data symbols mapped onto at least one signal subspace, including a code subspace, a frequency subspace, a path-diversity subspace, a wavelet sub space, and a polarization sub sp ace.

99. The method recited in claim 80 wherein providing for performing the reverse transform comprises performing a synthesis operation represented by a polyphase matrix.

100. The method recited in claim 80 wherein providing for performing the reverse transform comprises employing an operator having a plurality of orthogonal basis functions.

101. The method recited in claim 80 wherein at least one of providing for performing the reverse transform and providing for projecting a signal space is adapted to changing channel conditions.

102. The method recited in claim 80 wherein providing for performing the reverse transform and providing for projecting a signal space are implemented via providing for an enhanced reverse-transform operation.

103. The method recited in claim 80 wherein providing for projecting a signal space includes producing at least one projection operator having a form comprising at least one of Pₛ^{⊥}=I−S(S^{T}S)⁻¹S^{T} and Pₛ^{⊥}=I−S(S^{H}S)⁻¹S^{H}, where Pₛ^{⊥} is a projection operator, I is an identity matrix, S is an interference matrix, S^{T} is a transpose of the interference matrix, and S^{H} is a conjugate transpose of the interference matrix.

104. The method recited in claim 103 wherein the projection operator includes one or more regularisation parameters.

105. The method recited in claim 103 wherein providing for projecting a signal space includes configuring the projection operator to optimize at least one received signal parameter.

106. The method recited in claim 103 wherein providing for projecting a signal space includes adapting the projection operator to at least one of changes in the number of basis functions and changes in the basis function length.

107. The method recited in claim 103 wherein providing for projecting a signal space includes orthogonalizing a plurality of column vectors in the interference matrix S.

108. The method recited in claim 103 wherein providing for projecting a signal space includes generating the interference matrix S from a linear combination of interference vector subspaces.

109. The method recited in claim 80 wherein the composite signal includes at least one of a set of signals, including cdmaOne, cdma2000, 1xRTT, cdma 1xEV-DO, cdma 1xEV-DV, cdma2000 3x, WCDMA, Broadband CDMA, UMTS, GPS, OFDM, MC-CDMA, Spread-OFDM, HSDPA, and frequency-hopped signals.

110. A method for decomposing a composite signal comprising a plurality of signals of interest, the method comprising:
(a) providing for performing a reverse transform on the composite signal to produce a plurality of baseband signal portions; and
(b) for at least one of the plurality of signals of interest, providing for projecting a signal space corresponding to the plurality of baseband signal portions onto a signal space substantially orthogonal to an interference signal space, the interference space not including the at least one of the plurality of signals of interest.

111. The method recited in claim 110 wherein the composite signal includes at least one interfering signal that is not one of the plurality of signals of interest, and providing for projecting a signal space includes projecting a signal space corresponding to the plurality of baseband signal portions onto a signal space substantially orthogonal to the interference signal space, the interference space including at least one of the at least one interfering signal that is not one of the plurality of signals of interest.

112. The method recited in claim 110 wherein providing for projecting a signal space comprises providing for interference selection for selecting at least one interference component to include in the interference signal space.

113. The method recited in claim 112 wherein providing for interference selection includes employing at least one of an analytically determined interference distribution and a measured interference distribution for selecting the at least one interference component.

114. The method recited in claim 112 wherein providing for interference selection includes selecting the at least one interference component based on at least one of known channel measurements and known transmit spreading codes.

115. The method recited in claim 112 wherein providing for interference selection includes selecting the at least one interference component to improve at least one signal-quality parameter of at least one received signal.

116. The method recited in claim 116 wherein providing for interference selection is part of an iterative process of selecting the at least one interference component to improve the at least one signal-quality parameter, providing for updating at least one of the plurality of signals of interest, and providing for determining if at least one predetermined confidence measure is satisfied.

117. The method recited in claim 112 wherein providing for interference selection includes selecting the at least one interference component to improve at least one complexity/performance trade-off metric.

118. The method recited in claim 112 wherein providing for interference selection includes selecting the at least one interference component relative to its correlation with at least one of the plurality of signals of interest.

119. The method recited in claim 112 wherein providing for interference selection includes selecting the at least one interference component relative to at least one predetermined delay threshold.

120. The method recited in claim 110 wherein providing for performing the reverse transform includes performing at least one of a Fourier transform, a wavelet transform, a Walsh transform, and a Hankel transform.

121. The method recited in claim 110 wherein providing for performing the reverse transform includes performing at least one of a block transform, a sliding transform, a passband filtering operation, and a quadrature-mirror filtering operation.

122. The method recited in claim 110 wherein providing for performing the reverse transform includes receiving the composite signal with an antenna array.

123. The method recited in claim 122 wherein the antenna array includes at least one of a set of antennas including a plurality of spatially separated antennas and a plurality of differently polarized antennas.

124. The method recited in claim 122 wherein the antenna array further includes at least one of a plurality of filter banks and a plurality of Rake receivers.

125. The method recited in claim 110 wherein providing for performing the reverse transform includes at least one of equalizing and matched filtering the composite signal.

126. The method recited in claim 110 wherein providing for performing the reverse transform comprises providing for applying a despreading operator.

127. The method recited in claim 126 wherein providing for applying the despreading operator includes decoding at least one of a set of spreading codes, including Hadamard-Walsh codes, complex codes derived from DFT coefficients, Frank-Zadoff codes, and Chu sequences.

128. The method recited in claim 110 wherein providing for performing the reverse transform comprises providing for applying a square-matrix operator.

129. The method recited in claim 110 wherein providing for performing the reverse transform includes recovering transmitted data symbols mapped onto at least one signal subspace, including a code subspace, a frequency subspace, a path-diversity subspace, a wavelet subspace, and a polarization subspace.

130. The method recited in claim 110 wherein providing for performing the reverse transform comprises performing a synthesis operation represented by a polyphase matrix.

131. The method recited in claim 110 wherein providing for performing the reverse transform comprises employing an operator having a plurality of orthogonal basis functions.

132. The method recited in claim 110 wherein at least one of providing for performing the reverse transform and providing for projecting a signal space is adapted to changing channel conditions.

133. The method recited in claim 110 wherein providing for performing the reverse transform and providing for projecting a signal space are implemented via providing for an enhanced reverse-transform operation.

134. The method recited in claim 110 wherein providing for projecting a signal space includes producing at least one projection operator having a form expressed by at least one of Pₛ^{⊥}=I−S(S^{T}S)⁻¹S^{T} and Pₛ^{⊥}=I−S(S^{H}S)⁻¹S^{H}, where Pₛ^{⊥} is a projection operator, I is an identity matrix, S is an interference matrix, S^{T} is a transpose of the interference matrix, and S^{H} is a conjugate transpose of the interference matrix.

135. The method recited in claim 134 wherein the projection operator includes one or more regularisation parameters.

136. The method recited in claim 134 wherein providing for projecting a signal space includes configuring the projection operator to optimize at least one received signal parameter.

137. The method recited in claim 134 wherein providing for projecting a signal space includes adapting the projection operator to at least one of changes in the number of basis functions and changes in the basis function length.

138. The method recited in claim 134 wherein providing for projecting a signal space includes orthogonalizing a plurality of column vectors in the interference matrix S.

139. The method recited in claim 134 wherein providing for projecting a signal space includes generating the interference matrix S from a linear combination of interference vector subspaces.

140. The method recited in claim 110 wherein the composite signal includes at least one of a set of signals, including cdmaOne, cdma2000, 1xRTT, cdma 1xEV-DO, cdma 1xEV-DV, cdma2000 3x, WCDMA, Broadband CDMA, UMTS, GPS, OFDM, MC-CDMA, Spread-OFDM, HSDPA, and frequency-hopped signals.

141. A digital computer system programmed to perform the method recited in claim 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, or 140.

142. A computer-readable medium storing a computer program implementing the method of claim 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, or 140.
